(19) United States
(12) Patent Application Publication
(10) Pub. No.: US 2011/0247651 A1
(43) Pub. Date: Oct. 13, 2011

(54) Fabric Sweeper

(76) Inventors: Peter M. Neumann, Racine, WI (US); Jeremy F. Knopow, Burlington, WI (US); Raymond C. Sulin, Racine, WI (US); Matthew J. Forst, Oak Creek, WI (US); Nancy L. Broen, Racine, WI (US); Eugene Placzkowski, Racine, WI (US); Richard Graceffa, Racine, WI (US); Sergio Reyes Salgado, Racine, WI (US); David J. Prince, St. Paul, MN (US); Aaron J. Munsinger, Elk Mound, WI (US); Robert G. Fehr, Colfax, WI (US); Milton W. Erickson, Merrillan, WI (US); Micah L. Maraia, Menomonie, WI (US); Christopher Peterson, Chippewa Falls, WI (US); Robert C. Martineau, Chippewa Falls, WI (US); Scott A. Olson, Chippewa Falls, WI (US)

(21) Appl. No.: 12/984,741

(22) Filed: Jan. 5, 2011

Related U.S. Application Data
(63) Continuation-in-part of application No. 12/759,602, filed on Apr. 13, 2010.

(51) Int. Cl. D06G 1/00; B08B 1/00

(52) U.S. Cl. 134/6; 15/40

(57) ABSTRACT

The present invention is a device for use in cleaning a fabric surface of dust, dirt, pet hair and other debris present on the surface. The device includes a housing coupled to a base. The base is coupled to at least one movable cleaning member configured to engage a surface for picking up debris from the surface. The debris is deposited into a debris collection chamber by way of interaction with another portion of the device. The debris collection chamber is selectively emptiable by an operator thereof so that the device may be subsequently reused.

### CROSS-REFERENCE TO RELATED APPLICATIONS

This application claims a benefit of priority on U.S. patent application Ser. No. 12/759,602, filed Apr. 13, 2010 and entitled “Fabric Sweeper” and U.S. Design Patent Application Serial No. 29/365,134 filed on Jul. 2, 2010 and entitled “Lid for a Fabric Sweeper Device.”

### BACKGROUND OF THE INVENTION

1. Field of the Invention

The present invention relates to cleaning devices, and more specifically to a cleaning device for fabrics that is capable of picking up and retaining for disposal various debris located on a fabric surface.

2. Discussion of the Related Art

When cleaning fabric surfaces, oftentimes mechanical vacuum cleaning devices are utilized in order to effectively remove dirt, dust, and other debris from the fabric surface. However, due to the often large and cumbersome construction of these types of mechanical vacuum fabric cleaning devices, these devices are often not suitable for use in certain situations where the fabric surface to be cleaned is relatively small, or is positioned in a difficult to access location. In addition, for various instances of spot cleaning certain fabric surfaces, a large mechanical cleaning device is often impractical for the particular cleaning task.

Therefore, in order to provide a lightweight cleaning device that can be utilized as an alternative to larger mechanical vacuum cleaning devices for these types of situations, various types of alternative cleaning devices and brushes have been developed. For example, Tsuruzawa U.S. Pat. No. 3,747,152 discloses a cleaning brush with dust removing and collection means. The device includes a rotatable or slidable brush that is mounted to a housing that can be grasped by an individual to move the brush across a surface to be cleaned. The movable brush is formed with a number of bristles which are oriented generally oppositely to bristles on a pair of brush members disposed on the housing surrounding the brush. The bristles on the movable brush pick up dirt from the surface by contacting the dirt as the brush is moved across the surface. The bristles then rotate into engagement with the bristles on the brush members in the housing to dislodge the dirt from the movable brush. The dirt and dust dislodged by the brush members is then collected within the movable brush opposite the bristles for later removal through an opening in the housing to which the movable brush is mounted.

However, this device has certain shortcomings in that the ability of the brush to effectively retain any dirt, dust or other debris picked up by the movable brush is determined by the contact of the bristles on the brush with the bristles of the brush members. Because the movable brush necessarily has to move into contact with the brush members from the exterior of the device, the brush can dislodge the dirt, dust and other debris from the movable brush before the dirt is located within the brush housing. Furthermore, for that component of the dirt, dust and other debris that is actually contained within the housing as a result of the proper operation of the device, the debris must be dispensed by inverting the device and shaking the housing such that the debris moves through an opening in the housing, which is a highly inefficient manner to remove the dirt from the device.

Therefore, it is desirable to develop a lightweight, manually operable fabric surface cleaning or sweeping device that engages dirt, dust and other debris picked up off of a fabric surface in a manner which more effectively removes the debris from the surface and deposits this debris within a collection chamber positioned in the device. Further, it is also desirable to develop a fabric sweeper cleaning device in which the dust or debris collected by the device can be more easily dispensed of using the separate collection chamber.

### SUMMARY AND OBJECTS OF THE INVENTION

According to a primary aspect of the present invention, a fabric cleaning and/or sweeping device is provided with a housing that preferably includes at least one fabric cleaning member. In one embodiment, a pair of movable cleaning members is secured within a recess in the housing such that each member is engageable with the fabric to be cleaned and with the opposed fabric cleaning member. The movable cleaning members rotate with respect to the housing as the cleaning device is moved over the fabric surface, and pick up any dust, dirt or other debris on the fabric surface. The movable cleaning members are secured within the housing in a manner which enables the members to rotate independently of one another, but also that the cleaning members selectively come into contact with one another. When the cleaning members contact one another, the members effectively act as a cleaning mechanism for one another, urging the dust, dirt and other debris off of the opposite member and into a collection chamber for the device. The members can easily pick up dust, dirt and other debris from the fabric surface due to the construction of the cleaning members which include an outer surface formed of a material that readily attracts pet hair, crumbs, dust, lint, allergens and other materials present on the fabric surface. The materials are also chosen to be somewhat flexible such that the material, in addition to being cleaned by the material positioned on the opposed rotatable member, can be further cleaned of the dirt, dust and other debris picked up by the material as a result of the contact of the material on each cleaning member with the housing.

According to another aspect of the present invention, the housing preferably includes a dirt collection chamber with an open lower end that is in communication with the space within which the rotatable members are positioned such that the dirt and dust picked up by the cleaning members is diverted through the housing into the collection chamber. In one embodiment, the chamber is selectively emptiable. The housing may be selectively removable from a base so that the chamber may be emptied when it becomes full with debris and other collected materials. Alternatively, the rotatable members may be selectively removed from the housing such that the chamber is may be emptied through the space created by the absence of the rotatable members. In an alternative construction of the present invention, the housing may include a port or other means to allow access to the chamber from an exterior thereof so that the contents of the chamber may be removed by way of a secondary cleaning device such as, for example, a vacuum cleaner.

According to still another aspect of the present invention, the housing within which the cleaning members and the collection chamber are positioned is designed to enable easy handling and use by an individual to clean a fabric surface. Additionally, the housing is formed with a minimum of parts, which can each be formed of lightweight materials that are relatively low cost and easy to manufacture into the housing components. Numerous other aspects, features and advantages of the present invention will be made apparent from the following detail description taken together with the drawing figures.

### BRIEF DESCRIPTION OF THE DRAWINGS

The drawings illustrate the best mode currently contemplated of practicing the present invention.

In the drawings:

FIG. 1 is an isometric view of one embodiment of a fabric sweeper cleaning device of the present invention;

FIG. 2 is an isometric view illustrating the cleaning members of the device of FIG. 1;

FIG. 3 is an isometric view illustrating the removal of a collection chamber of the device of FIG. 1;

FIG. 4 is an end elevational view of the device of FIG. 1;

FIG. 5 is a side elevational view of the device of FIG. 1;

FIG. 6 is a cross-sectional view along line 6-6 of FIG. 1;

FIG. 7 is a cross-sectional view similar to FIG. 6 illustrating the movement of the cleaning members of the device of FIG. 1 when the device is moved in a first direction;

FIG. 8 is a cross-sectional view similar to FIG. 6 illustrating the movement of the rotatable members of the cleaning device when the device is moved in a second direction opposite to FIG. 7;

FIG. 9 is a cross-sectional view similar to FIG. 6 illustrating the movement of the rotatable cleaning members when the device is moved further in the direction of FIG. 8;

FIG. 10 is perspective view of another embodiment of fabric sweeper device viewed from in front of, above, and from the left side of the fabric sweeper;

FIG. 11 is a bottom plan view of the device of FIG. 10;

FIG. 12 is a top plan view of the device of FIG. 10;

FIG. 13 is a side elevation view of the device of FIG. 10, with the other side being a mirror image of the first side showing the rollers in phantom;

FIG. 14 is a front elevation view of the device of FIG. 10, with the rear being a mirror image thereof and showing the rollers in phantom;

FIG. 15 is a bottom plan view of the device of FIG. 10 with the rollers in place in phantom;

FIG. 16 is another bottom plan view of the device of FIG. 10 with the rollers removed;

FIG. 17 is a perspective view, viewed from below the fabric sweeper or FIG. 10 with the rollers removed;

FIG. 18 is a perspective view of yet another embodiment of the fabric sweeper design, viewed from in front of, above, and from the right side of the fabric sweeper;

FIG. 19 is a side view of the device of FIG. 18 with the other side being a mirror image of the first side and showing the rollers;

FIG. 20 is a rear elevation view thereof, with the front being a mirror image of the rear and showing the rollers;

FIG. 21 is a top plan view of the device of FIG. 18;

FIG. 22 is a bottom plan view of the device of FIG. 18 showing the rollers;

FIG. 23 is a magnified perspective view, viewed from below, from the left side, and toward the rear of the fabric sweeper and the rollers;

FIG. 24 is a magnified perspective view, viewed from above, from the right side, and toward the front of the fabric sweeper;

FIG. 25A is a perspective view of still another embodiment of the fabric sweeper, viewed from in front of, above, and from the left side of the fabric sweeper;

FIG. 25B is a bottom plan view of the device of FIG. 25A;

FIG. 26 is a perspective view of yet another embodiment of the fabric sweeper, viewed from in front of, above, and from the left side of the fabric sweeper;

FIG. 27 is a rear elevation view of the device of FIG. 26, with the front being a mirror image of the rear showing the roller in place;

FIG. 28 is a bottom plan view of the device of FIG. 26 with the roller in place;

FIG. 29 is a cutaway type view of the device of FIG. 26 focusing on the roller arrangement;

FIG. 30 is an isometric view of a housing of a device incorporating a handle design of another embodiment of the invention;

FIG. 31 is a side elevation view of the housing of FIG. 30;

FIG. 32 is a side elevation view of the housing of FIG. 30 shown from the opposite side of FIG. 31;

FIG. 33 is a rear end elevation view of the housing of FIG. 30;

FIG. 34 is a front end elevation view of the housing of FIG. 30;

FIG. 35 is a top plan view of the housing of FIG. 30;

FIG. 36 is an isometric view of a cleaning device according to another construction of the present invention;

FIG. 37 is a top plan view of the cleaning device of FIG. 36;

FIG. 38 is a partially exploded view of the cleaning device of FIG. 36;

FIG. 39 is bottom plan view of a locking mechanism according to the present invention;

FIG. 40 is an isometric view of a cleaning device according to yet another construction of the present invention;

FIG. 41 is a partial view of a locking mechanism of the cleaning device of FIG. 40 shown being moved between a locked and unlocked position;

FIG. 42 is an isometric view of still another embodiment of a cleaning device according to the present invention;

FIG. 43 is an isometric view of the cleaning device of FIG. 42 showing a housing of the cleaning device rotated with respect to a base so that a debris collection chamber may be emptied;

FIG. 44 is an isometric view of a cleaning device of still another embodiment of the present invention;

FIG. 45 is an isometric view of the cleaning device of FIG. 44 showing a housing of the cleaning device rotated with respect to a base for emptying of a debris collection chamber;

FIG. 46 is an isometric view of a cleaning device according to another construction of the present invention;

FIG. 47 is an isometric view of still another embodiment of a cleaning device according to the present invention;

FIG. 48 is an isometric view of yet another embodiment of a cleaning device according to the present invention;

FIG. 49 is an isometric view of another embodiment of a cleaning device according to the present invention;

FIG. 50 is a partial view of the cleaning device of FIG. 48 showing a release mechanism thereof;

FIG. 51 is an isometric view of another embodiment of a cleaning device according to the present invention;

FIG. 52 is a partial view of the cleaning device of FIG. 51 showing a release mechanism of a housing thereof;

FIG. 53 is an isometric view of another embodiment of a cleaning device according to the present invention;

FIG. 54 is a partial view of the cleaning device of FIG. 53 showing a release mechanism of a housing thereof;

FIG. 55 is an isometric view of another embodiment of a cleaning device according to the present invention;

FIG. 56 is a partial view of the cleaning device of FIG. 55 showing a release mechanism of a movable cleaning member thereof;

FIG. 57 is an isometric view of a cleaning device of another embodiment of the present invention showing the cleaning device in an unfolded configuration; and

FIG. 58 is an isometric view of still another cleaning device according to the present invention.

### DETAILED DESCRIPTION OF THE INVENTION

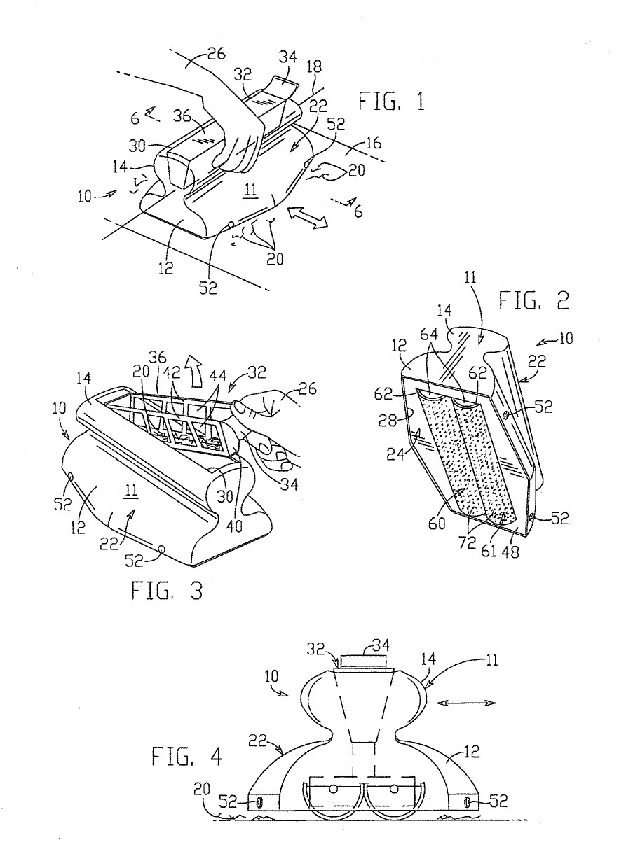

With reference now to the drawing figures in which like reference numerals designate like parts throughout the disclosure, a fabric cleaning or sweeping device constructed according to the present invention is indicated generally by the reference number 10 in FIG. 1. The fabric sweeper or device 10 preferably includes a housing 11 with a base portion 12 and a handle portion 14 extending upwardly from the base portion 12. When in use, the base portion 12 of the device 10 is positioned on a fabric surface 16 and moved in a direction generally perpendicularly to the long axis 18 of the device 10 in order to pick up debris 20 disposed on the fabric surface 16.

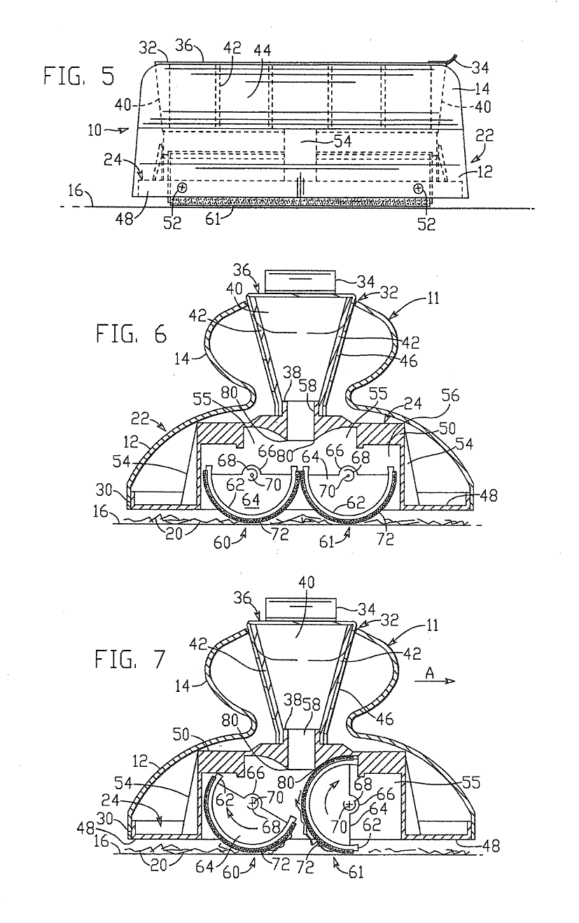

Referring now to FIGS. 1-6, the device 10 is formed with an outer housing 22 and an inner housing 24. Both the outer housing 22 and inner housing 24 are formed of a generally rigid material, that is also preferably lightweight, in order to enable the device 10 to be easily manipulated by an individual's hand 26, as best shown in FIG. 1. Most preferably, each housing 22 and 24 is constructed of a plastic material, such that the shape of the respective housings 22 and 24 can be easily modified as desired, and formed in a conventional plastic molding process, e.g., injection molding.

The outer housing 22 includes a lower opening 28 within which the inner housing 24 is located, and an upper opening 30 positioned generally opposite the lower opening 28. The upper opening 30 can have any desired shape, but is preferably rectangular in shape in order to accommodate a collection chamber or bin 32 therein. The bin 32 includes a handle 34 at one end to facilitate the removal of the bin 32 from within the upper opening 30 in the outer housing 22. The bin 32 is also formed of a generally lightweight material, such as a plastic material, and includes a wide, closed end 36 at the top of the bin 32, and a narrow open end 38 at the bottom of the bin 32. Inwardly tapering end walls 40 extend between the closed end 36 and open end 38 at each end of the bin 32, and are joined by sidewalls 42. The side walls 42 are integrally formed with the end walls 40 and include a number of open sections 44 spaced therealong. The open sections 44 allow an individual to view the interior of the bin 32 in order to determine how much debris 20 has been collected therein. The open sections 44 are preferably enclosed by a transparent material 46 that can extend from one side of the open end 38 over the adjacent side wall 42, over the top of the bin 32 to form the closed end 36, and down over the opposed side wall 42. In this embodiment, the transparent material 46 allows an individual to view the interior of the bin 32 regardless of whether the bin 32 is positioned within or removed at least partially from the upper opening 30 in the device 10. Additionally, to provide a more aesthetically pleasing appearance to the device 10, the closed end 36 of the bin 32 can be formed of material similar to the material forming the housing 22 to provide a more seamless appearance between the closed end 36 of the bin 32 and the handle portion 14 of the device 10.

Referring now to FIGS. 4-6, the inner housing 24 includes a lower portion 48 and an upper portion 50. The lower portion 48 extends outwardly to conform to the shape of the lower opening 28 in the outer housing 22, and is fixedly secured to the outer housing 22 by suitable fasteners 52. The upper portion 50 is spaced above the lower portion 48 by a pair of opposed supports 54 and end walls 55, preferably integrally formed between the lower portion 48 and the upper portion 50, in order to define a recess 56 between the side supports 54 and end walls 55. The upper portion 50 also includes a central opening 58 having lower edges 80 that extends completely through the upper portion 50 and allows communication between the recess 56 and the narrow open end 38 of the bin 32. To keep the device 10 relatively lightweight, the inner housing 24 is formed of a suitable lightweight material, such as a plastic material.

The recess 56 also houses a pair of cleaning members 60 and 61. The members 60, 61 are generally semi-cylindrical in shape, such that each member 60, 61 includes a curved surface 62, and a pair of arcuate end walls 64. Each end wall 64 includes a protrusion 66 extending outwardly therefrom in which is defined a bore 68 that receives a fastener 70 in order to rotatably secure each end wall 64 to the adjacent end wall 55 of the recess 56. While the preferred embodiment discloses cleaning members 60, 61 that are generally semi-cylindrical in shape, other suitable shapes for the members 60, 61 are also contemplated. Further, the materials utilized to form the cleaning members 60, 61 are selected to maintain the overall light weight for the device 10, such that preferred materials for the cleaning members 60, 61 can include various lightweight metals and plastics.

Each cleaning member 60, 61 also includes a layer of cleaning material 72 secured to the member 60, 61 on the curved surface 62 opposite the end wall 64. The material 72 can be selected from any suitable material capable of picking up and retaining various dirt, dust, pet hair, crumbs, lint and other allergens from a fabric surface 16 such as a number of teeth disposed, and possibly integrally formed on each member or a material secured to the members 60, 61. Preferably, the material is formed of a cloth-like material, with a particularly preferred material being an unidirectional, fabric, such as velour. The layer of cleaning material 72 is secured to the curved surface 62 of the cleaning members 60, 61 in any suitable manner, but is preferably fixedly secured to the curved surface 62 by an adhesive.

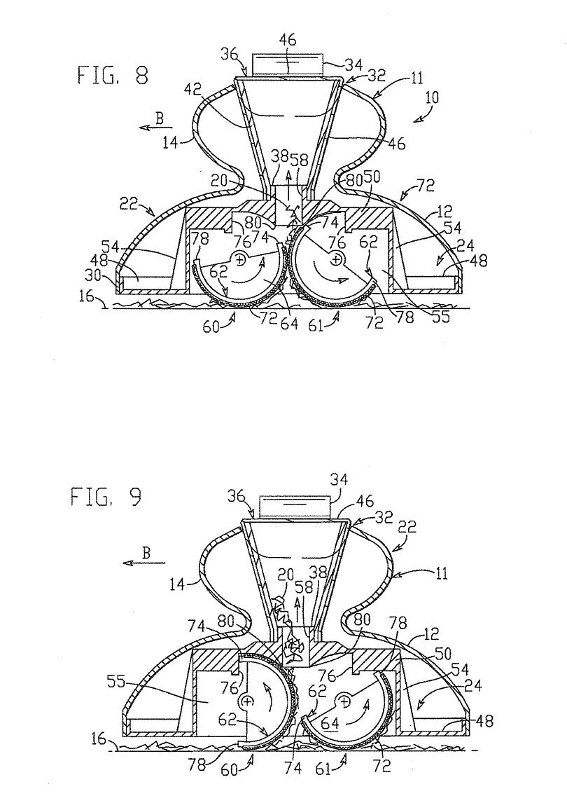

The cleaning members 60, 61 are secured within the recess 56 such that the layer of cleaning material 72 on each member 60, 61 extends below the lower portion 48 of the inner housing 24 and into contact with a fabric surface 16 over which the device 10 is moved. Each member 60, 61 is rotatable within the recess 56 between a first position where an inner side 74 (e.g., FIG. 8) is rotated into contact with an annular shoulder 76 (e.g., FIG. 8) formed on the upper portion 50 of the inner housing 24 adjacent the opening 58, and a second position where an outer side 78 (e.g., FIG. 8) of each member 60, 61 is rotated into contact with the upper portion 50 adjacent the corresponding side support 54. Additionally, the thickness of the layer of cleaning material 72 on each member 60, 61 is selected to enable the material 72 on each member 60, 61 to contact the material 72 on the opposed cleaning members 60, 61 for a purpose to be described.

In operation, referring now to FIGS. 7-9, the device 10 is placed against and moved across a fabric surface 16, and the cleaning members 60, 61 each rotate in a clockwise direction when the device 10 is moved in a direction indicated by arrow A in FIG. 7. As the members 60, 61 rotate in the clockwise direction, the layer of cleaning material 72 on each member 60, 61 contacts the debris 20 on the fabric surface 16 and picks up the debris 20 such that the debris 20 remains on the cleaning material layer 72. The device 10 is continually moved in the direction indicated by arrow A until the cleaning members 60, 61 are moved into the position shown in FIG. 7.

At this point, the device 10 is moved in the opposite direction indicated by arrow B in FIG. 8, such that members 60, 61 rotate in a counterclockwise direction. In doing so, the cleaning material layer 72 on the inner side 74 of member 60 contacts the cleaning material layer 72 adjacent the inner side 74 of cleaning member 61. As the respective layers 72 move past and contact one another, the debris 20 on the member 61 is removed and pushed through the central opening 58 in the upper portion 50 into the open end 38 of the bin 32. The debris 20 engaged between the members 60, 61 is continually urged upwardly into the opening 58, and cannot fall back on the surface 16 due to the close spacing of the members 60, 61. At the same time, the cleaning material layer 72 spaced from the inner side 74 of member 61 comes into contact with the fabric surface 16 in order to pick up additional debris 20 from the surface 16. Movement in the direction indicated by arrow B is continued in this manner until, as best shown in FIG. 9, the position of the cleaning members 60, 61 are essentially reversed from FIG. 7. From the position shown in FIG. 9, the device 10 is again moved in a direction indicated by arrow A in FIG. 7 such that the inner side 74 of cleaning member 61 comes into contact with and cleans the debris 20 off of the cleaning material 72 of cleaning member 60, which picks up debris 20 from the surface 16 as it is moved. This process can be repeated as many times as necessary in order for the cleaning members 60, 61 to remove all of the debris 20 off of the fabric surface 16.

The removal of the debris 20 from the cleaning material layer 72 on each cleaning member 60, 61 is further facilitated by the presence of the debris diverting edge 80 formed on the upper portion 50 of the inner housing 24 on each side of the central opening 58. The edges 80 on each side of the opening 58 contact the cleaning material layer 72 on the respective cleaning members 60, 61 when the members 60, 61 move into the positions shown in FIGS. 7 and 9 to assist in diverting and removing the debris 20 from the cleaning material 72. The edges 80 contact the layers 72 on the members 60, 61 to compress the layers 72 and scrape or otherwise direct the debris 20 from the layers 72 into the opening 58. Continued motion of the members 60, 61 moves the layers 72 along the edges 80 to remove additional debris 20 from the members 60, 61.

After the debris 20 has been removed from the fabric surface 16, an individual can remove and replace the bin 32, if necessary, or can utilize the device in order to remove debris 20 from an additional fabric surface or surfaces 16. In addition, as opposed to the bin 32 being designed for removal and disposal separately from the device 10, the entire device 10 can be designed to be disposed once the bin 32 has been filled with debris 20 removed from one or more fabric surfaces 16.

Additionally, separate from the previously described embodiments, other modifications to the device 10 are also contemplated as within the scope of the invention. For example, the chamber or bin 32 can be integrally formed with the outer housing 22, such that the entire device is disposable. Also, the chamber 32 can include or be formed of a hair or lint attracting material, such as a strip of a tacky material or a hook and loop material to trap any lint, hair or other debris contacting it. Also, the opening 58 in the lower housing 24 could be moved to one side or the other of the lower housing 24, along with a corresponding shift in the location of the chamber 32.

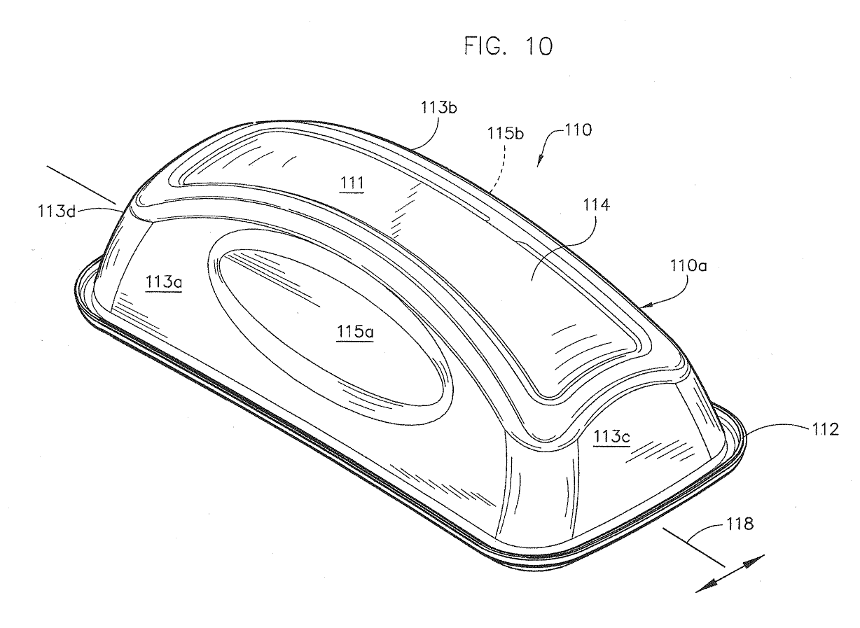

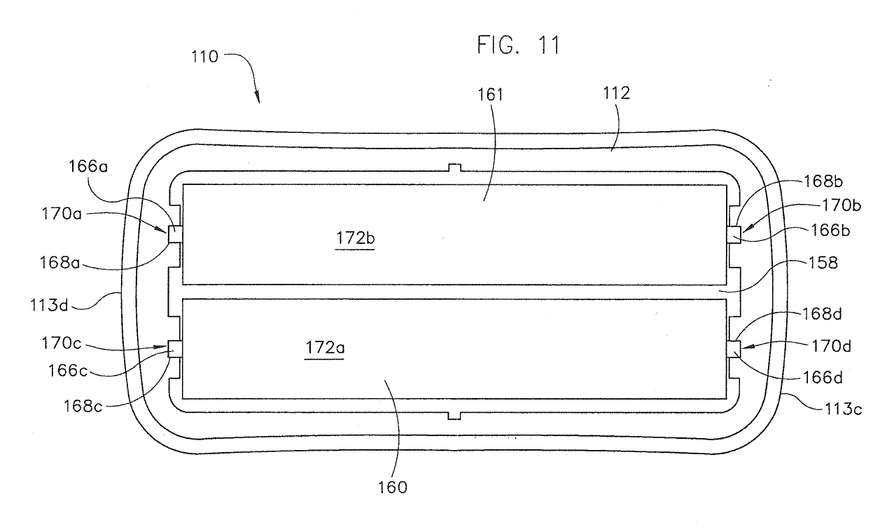

FIG. 10 shows an alternative device 110. The device 110 has a housing 110a with base portion 112 and a handle portion 114 preferably connected by an adhesive or heat staking. The device cleans the surface along axis 118. The handle portion 114 preferably has a top 111, a first side 113a, an opposing second side 113b, a front side 113c, and back side 113d. The first side and the second side have grooves 115a, 115b for receiving the user's hand and fingers. The grooves allow the user to comfortably grip a handle portion. FIG. 11 shows the underside of the device 110. As seen in FIG. 11 the base portion 112 is configured to receive cleaning members 160, 161. The cleaning members are preferably covered with cleaning material 172a, 172b such as an unidirectional velour. The cleaning members 160, 161 are preferably semi-circular rollers such as those described above. In this embodiment, the rollers 160, 161 are attached to the base portion 112 with fasteners 170a, 170b and 170c, 170d located at each end of the roller. In between the rollers is a central opening 158. In this embodiment, fasteners 170a, 170b are preferably constructed of two main elements- for example, protrusions 166a and 166b that are respectively received in the cavities 168a and 168b for roller 161. Similarly, roller 160 has fasteners 170c, 170d that include protrusions 166c and 166d that are respectively received in the cavities 168c and 168d.

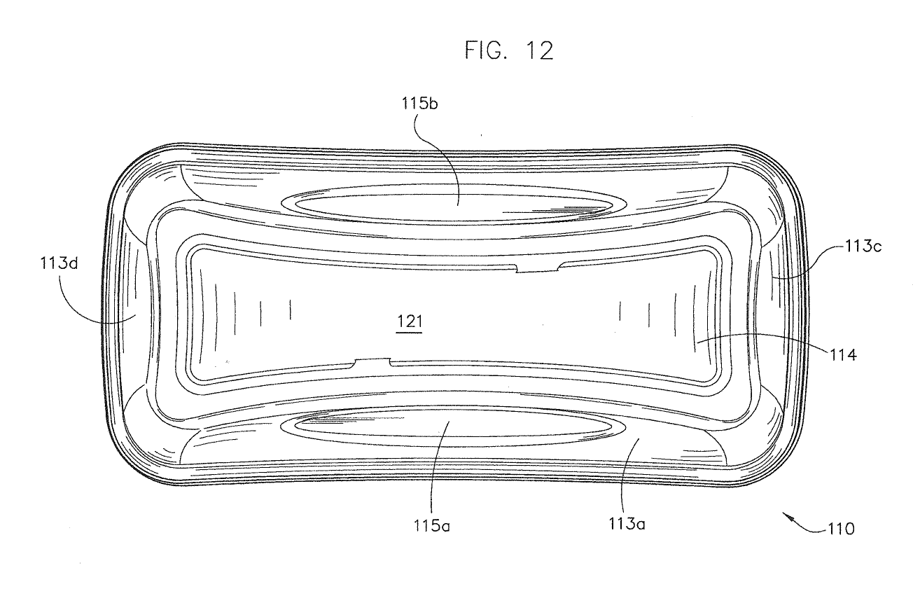

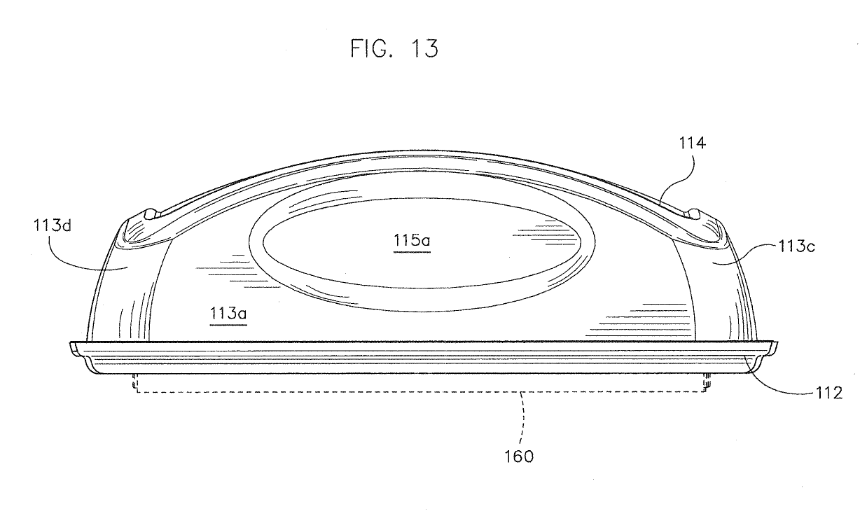

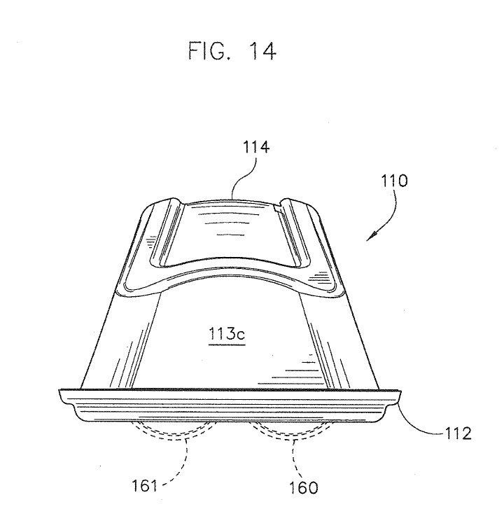

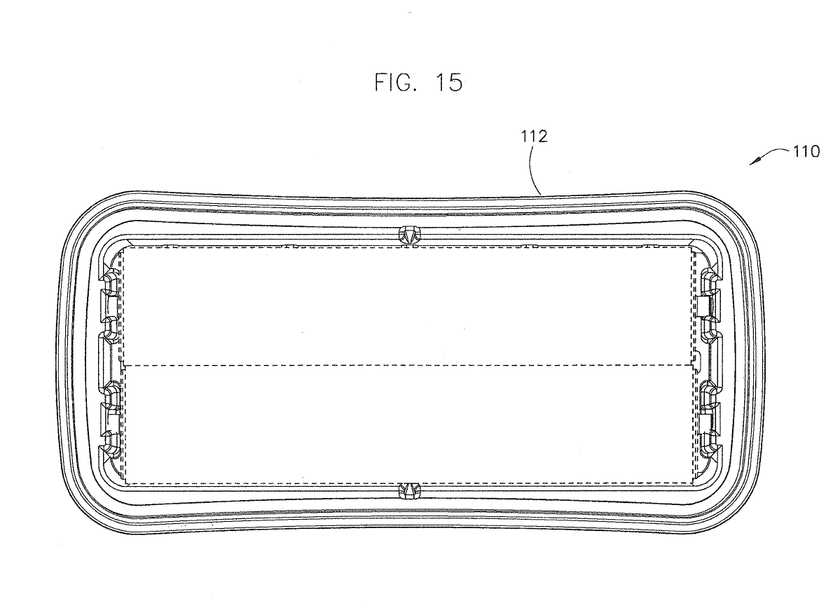

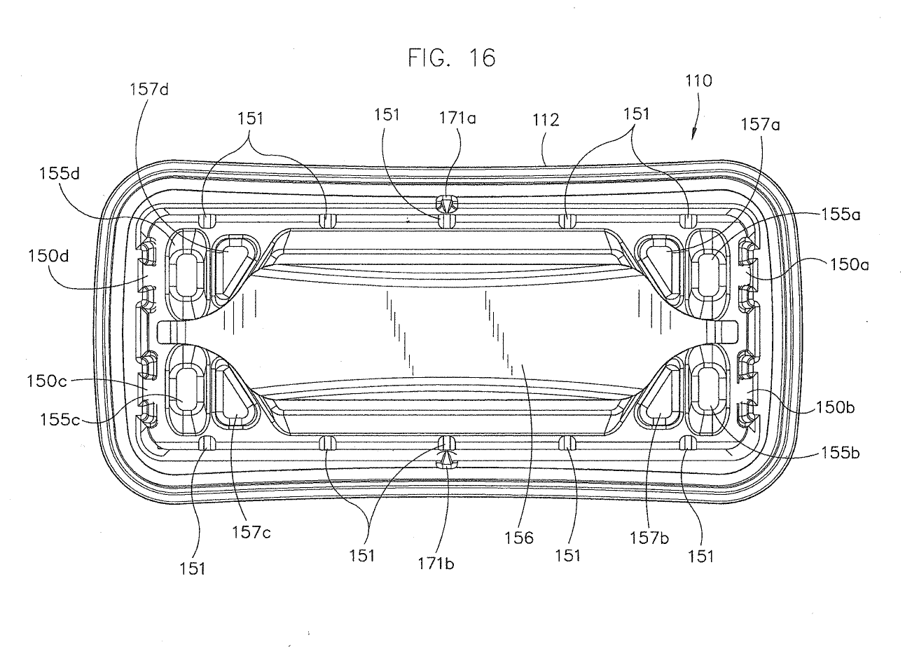

As shown in FIGS. 12-15, handle portion 114 has a top 121 that is preferably smooth and rounded. The sides 113a, 113b, 113c, 113d preferably have rounded corners as shown.

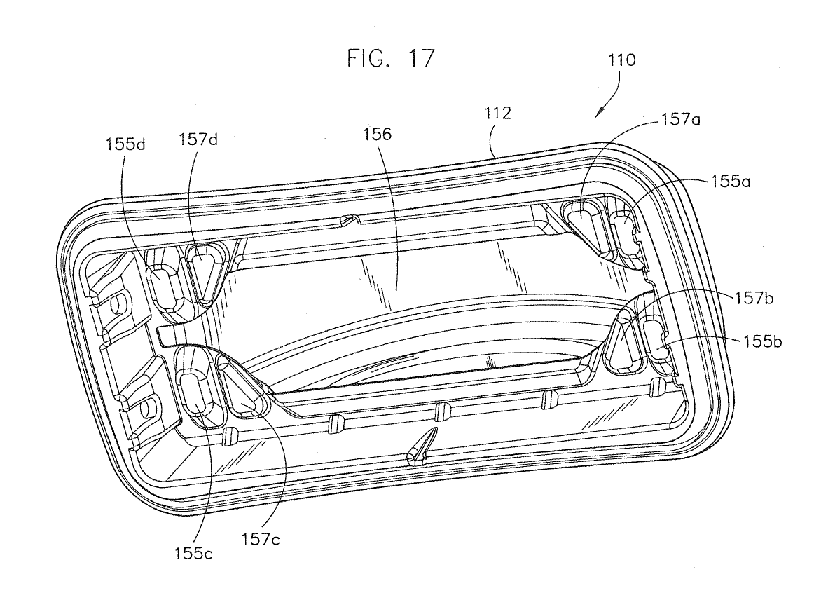

FIGS. 16 and 17 show the base portion 112 of the device 110 with the rollers removed. When the rollers are on place, they fit into fastening clip cavities 150a-150d. Handle portion 114 and base portion 112 are connected and/or aligned at points 151 as shown. In one embodiment, ribs may be present (on either portion) to help align the handle and base portions 114, 122 respectively and also keep the handle portion stable and firm. Stops 155a-155d help to restrict the movement of the rollers. Protrusions 157a-157d are preferably next to the stops 155a-155d. A rib may be between these to add stability. As handle portion 114 and base portion 112 are essentially hollow, they define a recess 156 into which debris that is picked up by the rollers is stored. In one embodiment, the handle 114 and base portion 112 are transparent so that the user can easily determined when the recess 156 is full of debris. In this embodiment, since the top and bottom portions are permanently connected at, for example, points 151 and/or points 171a,b and the rollers are locked into place, the device is then discarded along with the debris. A new device then must be purchased and used for further cleaning.

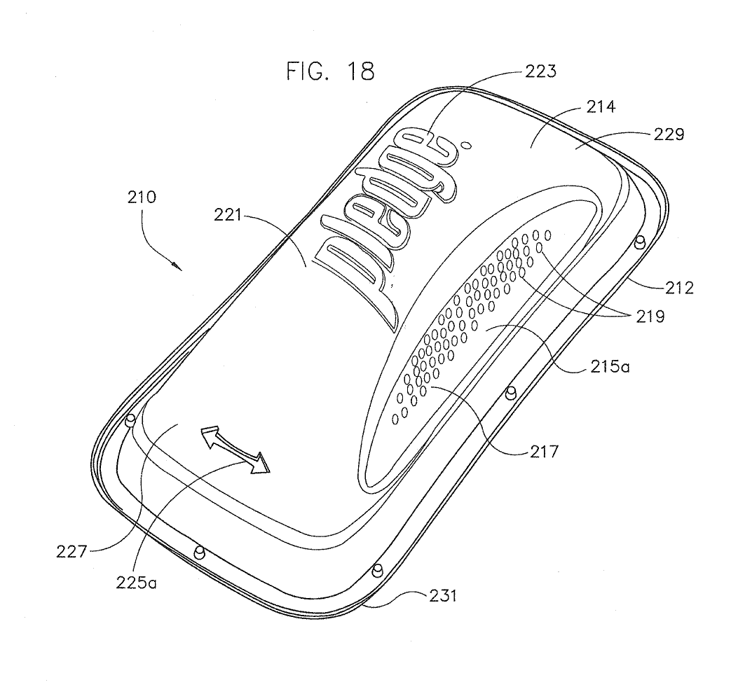

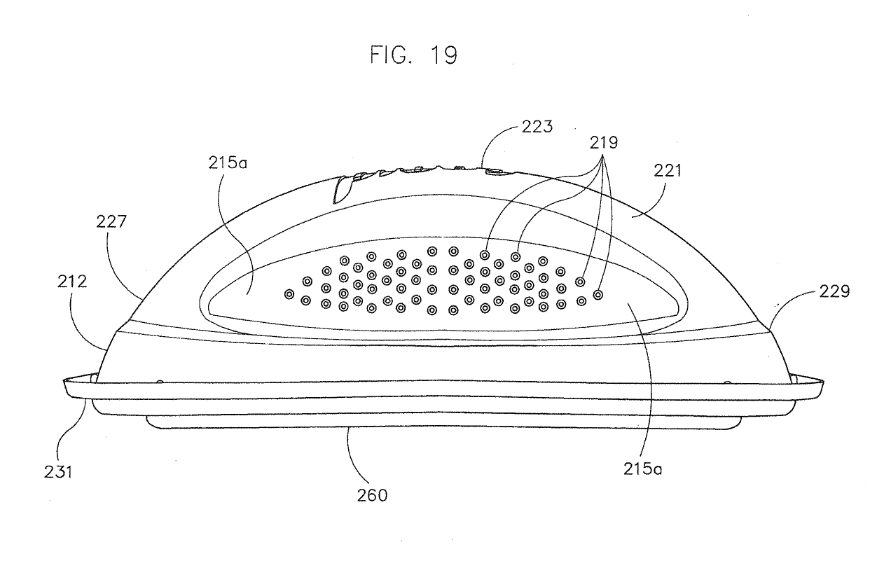

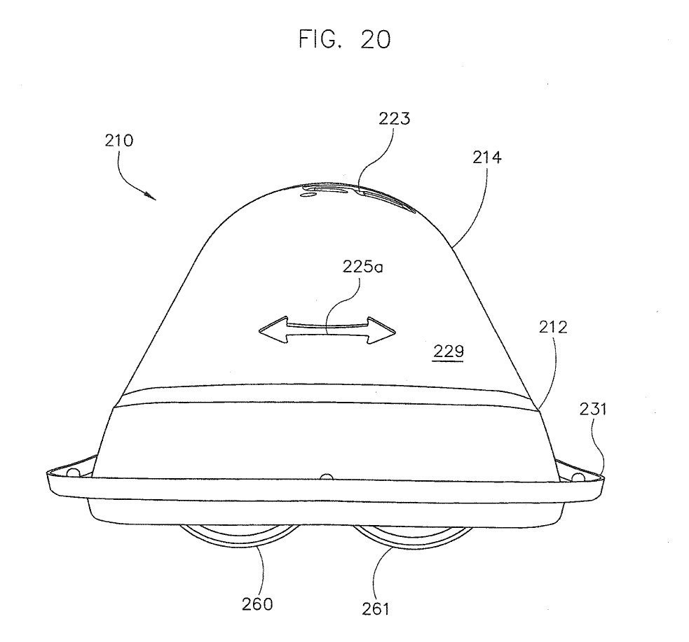

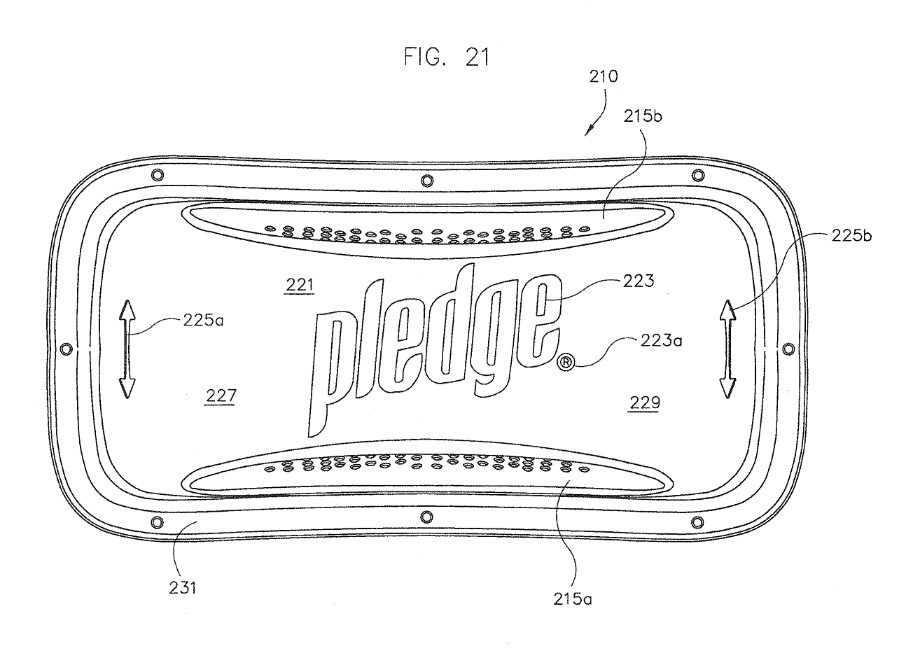

Another embodiment is shown in FIGS. 18-24. The device 210 is somewhat similar to device 110 but it contains additional features. The device 210 has a handle portion 214 and a bottom portion 212 connected preferably by heat formed connector stakes 271a-f that fit into holes. On the top 221 of the handle portion 214 are indicia 223. The indicia 223 preferably indicate the device's type or brand and may also consist of a logo as well as the trademark registration symbol 223a. Additional indicia 225a,b may be located at the front 227 and back 229 of the device 210. The indicia may include an arrow that indicates to the user that preferred direction of movement for the device.

In this embodiment, the grooves 215a,b, preferably having textured surface 217 consisting of small protrusions or indentations, grip points 219 that assist in the gripping of the device 210. This embodiment may also include ridge 231 around bottom portion 212. The ridge 231 may have a rounded lip to prevent snags. As best shown in FIGS. 19-21, this embodiment is more rounded and almost appears to be a semi circle. As shown, two rollers 260, 261 are located partially within the outer shell of the device 210. The grip points 219 and indicia 223 may be embossed out or in.

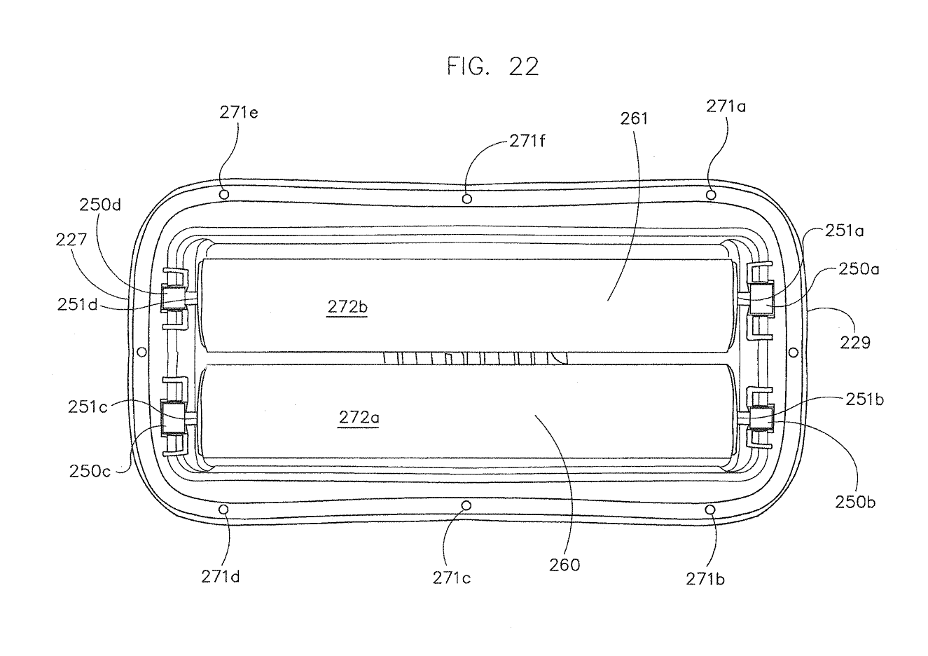

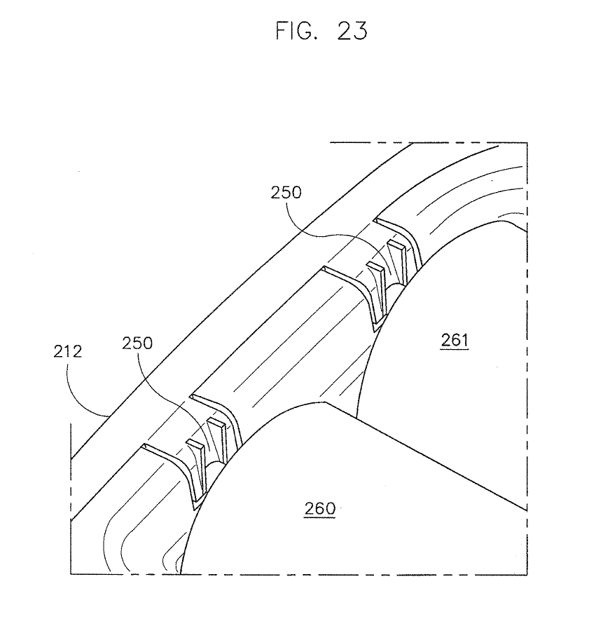

FIGS. 22 and 23 show rollers 260, 261 covered with a cleaning fabric 272, 272b. A somewhat different fastening mechanism for the rollers 260, 261 is also shown. For example, here spring snaps receive a protrusion on the rollers 260, 261 for easier assembly. As best shown in FIG. 23, the bottom of the base portion 212 has ramps or leads 250 to help assemble the rollers 260, 261 into the base 212. The rollers 260,261 may have protruding axles 251a-251d of differing sizes which interact with the leads 250a-250d.

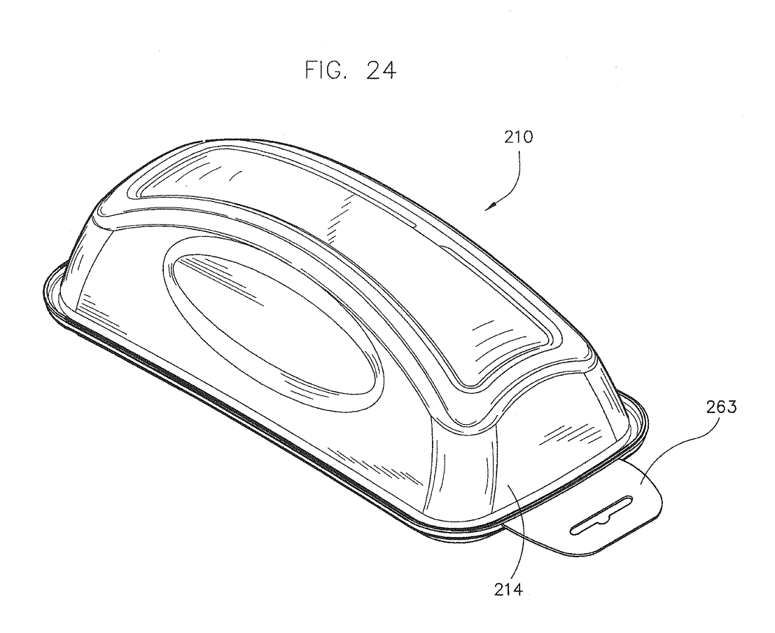

FIG. 24 shows a hanger 261 as an integral part of the handle portion 214. In this embodiment, a hanger 261 is preferably constructed of plastic and is used to hang the device 210 from a hook on store display.

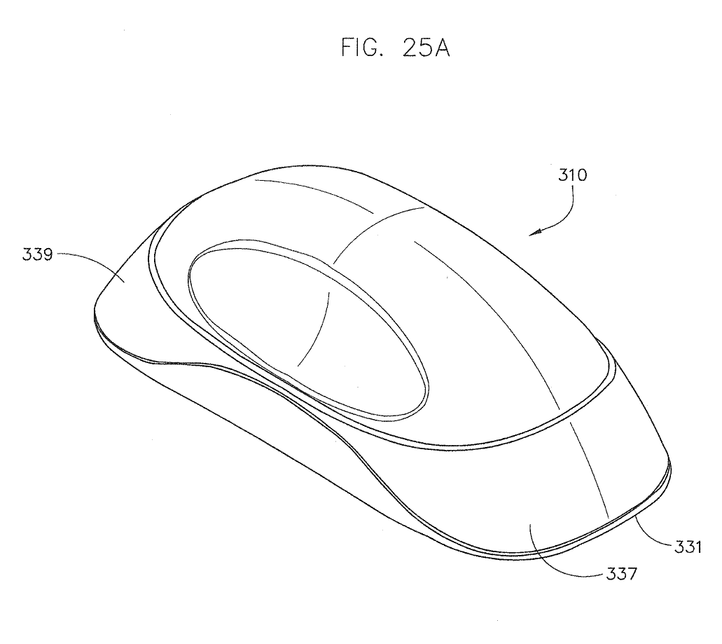

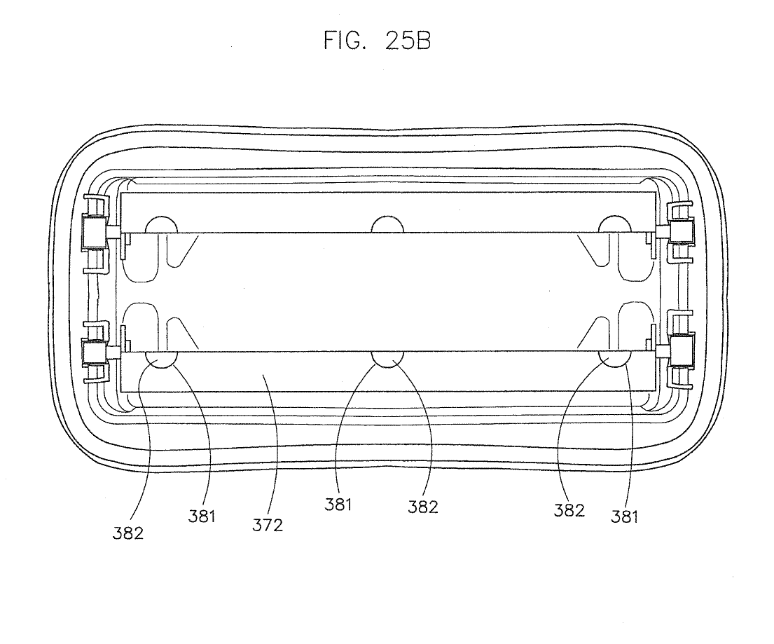

FIG. 25A shows still another embodiment. In this embodiment, device 310 has a very small ridge 331 and also has a more aggressively sloping front 337 and rear 339.

FIG. 25B shows the bottom of the device 310 shows scallop cuts 381 in the fabric 372 and the mating bosses 383 on the rollers 360, 361. In other embodiments, these scallops 384 are not necessary as the fabric would just be cut into rectangles and folded over both edges of the roller, not just the one.

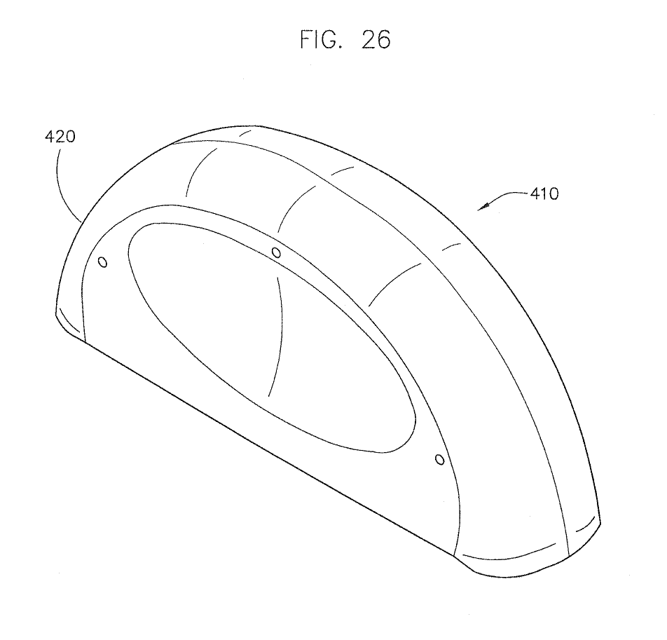

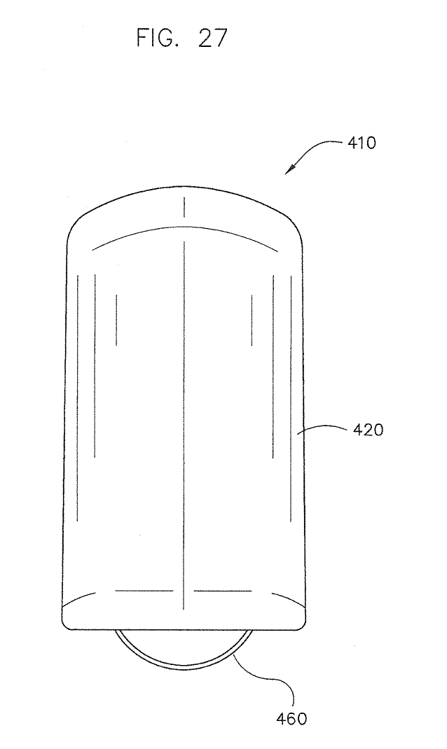

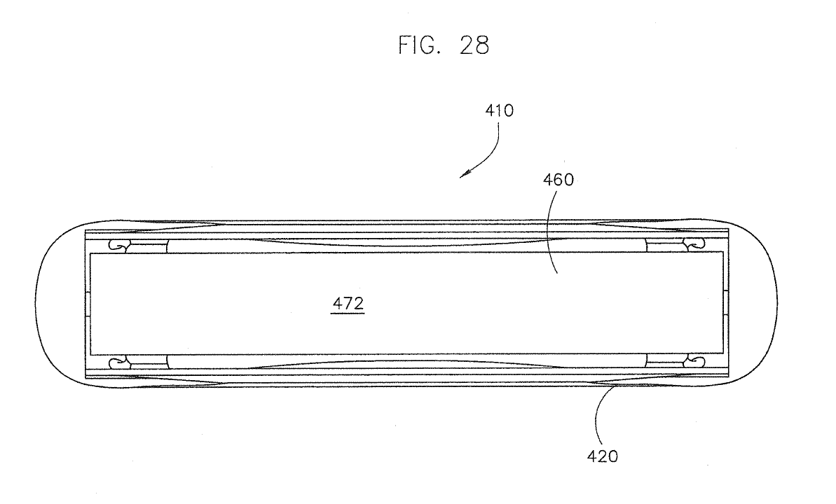

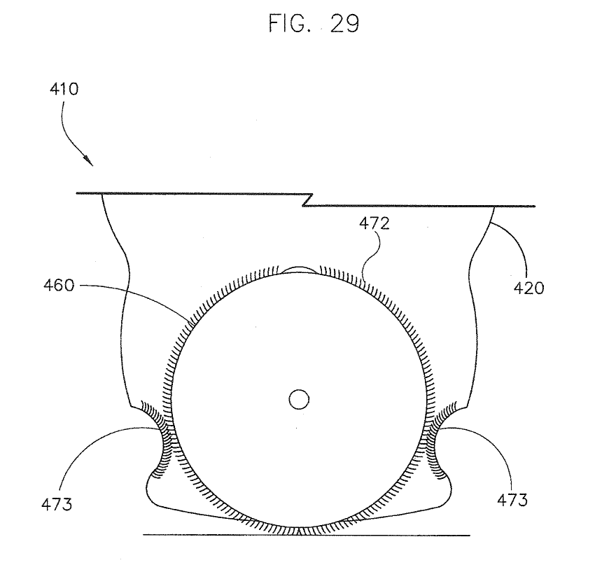

FIGS. 26-29 show yet another embodiment. This embodiment of device 410 has a single main roller 460 mounted in a semi circular housing 420. The main roller 460 attracts and picks up hair, while internally two small sections of directional material 473 attached to the housing 420 shed the hair from the main roller 460. This leaves the hair trapped inside the housing. The main roller 460 only rotates about 90 degrees in both directions. A stop locks the main roller 460 at a specific point to pick up hair, then when rolled in the reverse direction the roller 460 will almost roll 180 degrees which brings the hair up into the housing 420. The roller 460 locks again.

The motion is repeated until the housing 420 is full. The process picks up hair because the directional material is opposing one another. The velour 473 attached to the housing 420 “lays” down while the velour 472 on the large roller 460 brings in hair. When the device 410 reverses direction, the hair on the large roller 460 will pass the same small strip of velour 473 but now the velour 473 on the large roller 460 will “lay” down and the smaller strip of velour 473 traps the hair inside the housing 420.

FIGS. 30-35 illustrate another embodiment of the invention. Referring now to FIG. 30, the device 510 includes a housing 511 including a lower end coupled to the base (not shown) and an upper end, and a recess is defined between the lower end and the upper end. The base of the present embodiment may be like those disclosed with respect to the previous embodiments or any other suitable alternative. In particular, the base may be configured for supporting one or more cleaning members of the kind discussed in this application. For instance, the one or more cleaning members may be cylindrical or semi-cylindrical rollers rotatably mounted within an opening in the base and in communication with the housing to transport debris carried on the cleaning members to the housing 511 for storage and ultimately disposal.

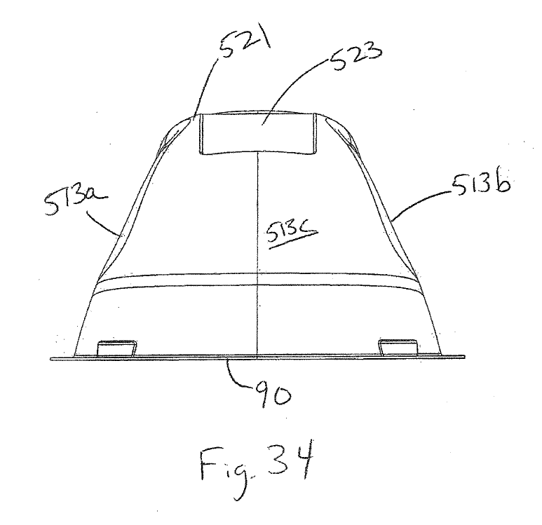

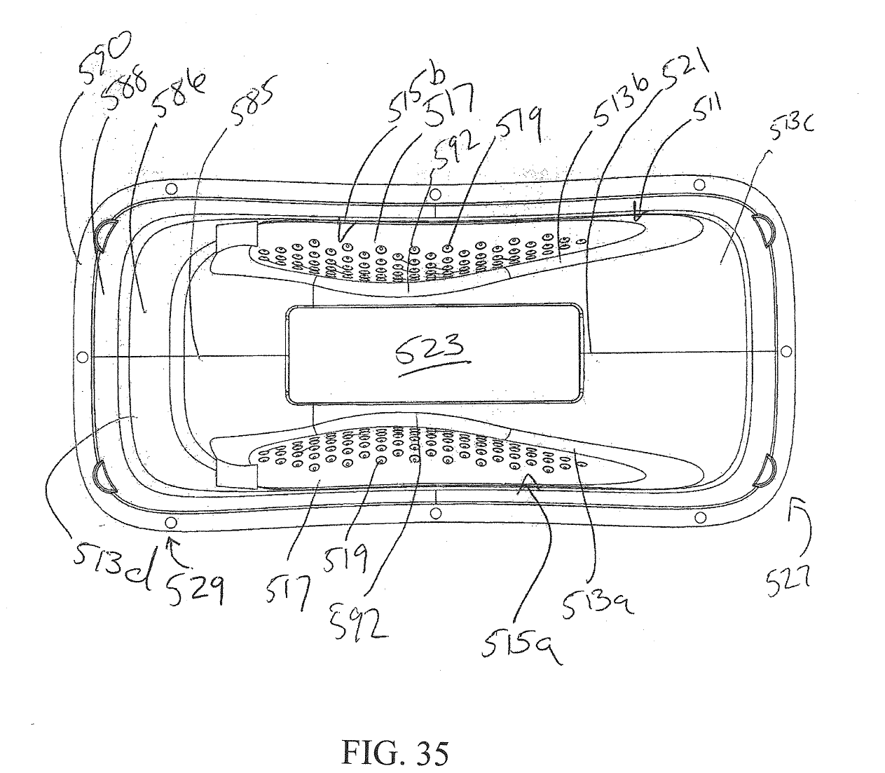

The housing 511 defines a handle portion 514 for comfortably receiving a user's hand. Handle portion 514 includes a top 521 integrally formed with four sides 513a, 513b opposite 513a, 513c, and 513d opposite 513d. Top 521 may include indicia 523 or other marking over a portion of top 521. Indicia 523 may provide product identification information, instructions for operation or any other such indicia as is readily understood. Referring momentarily to FIG. 35, top 521 may have a generally “hourglass” shape when viewed from above. In other words, a plan view of top 521 approximates the shape of an hourglass. In particular, near a front 527 and rear 529, top 521 is substantially wider as compared to points between front 527 and front 529. Indentations 592 are formed on opposing sides of top 521 at a point along the length of top 521 to define an area about which the user's fingers may be comfortably received about sides 513a, 513b.

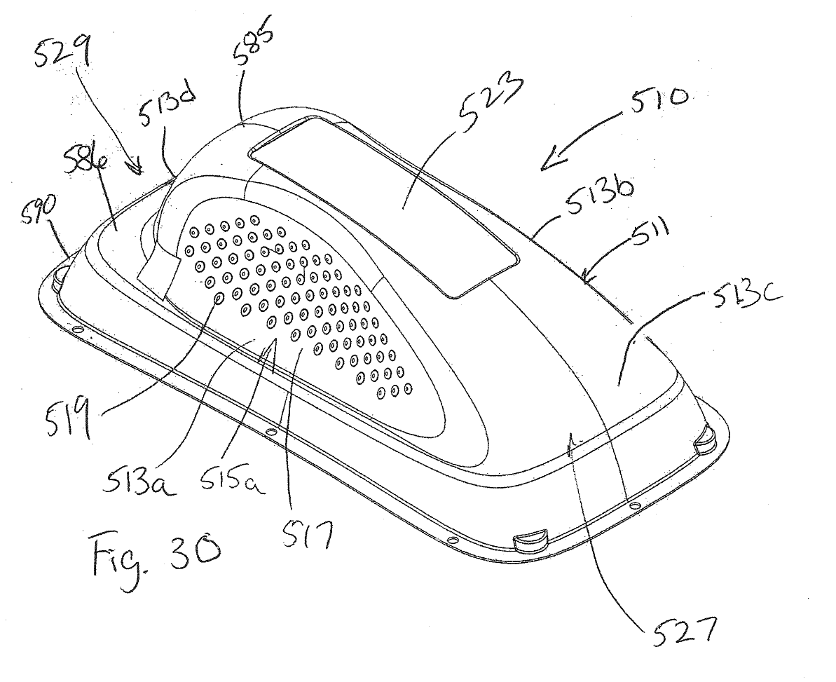

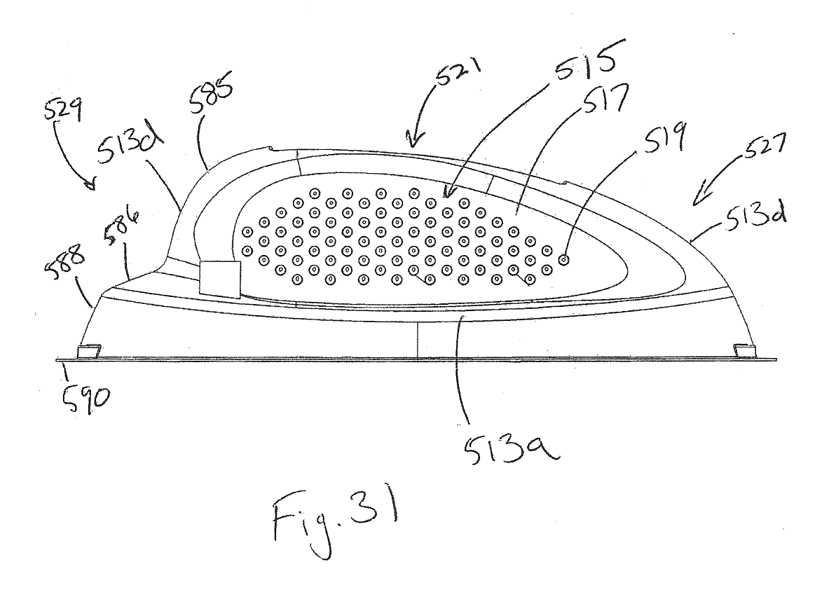

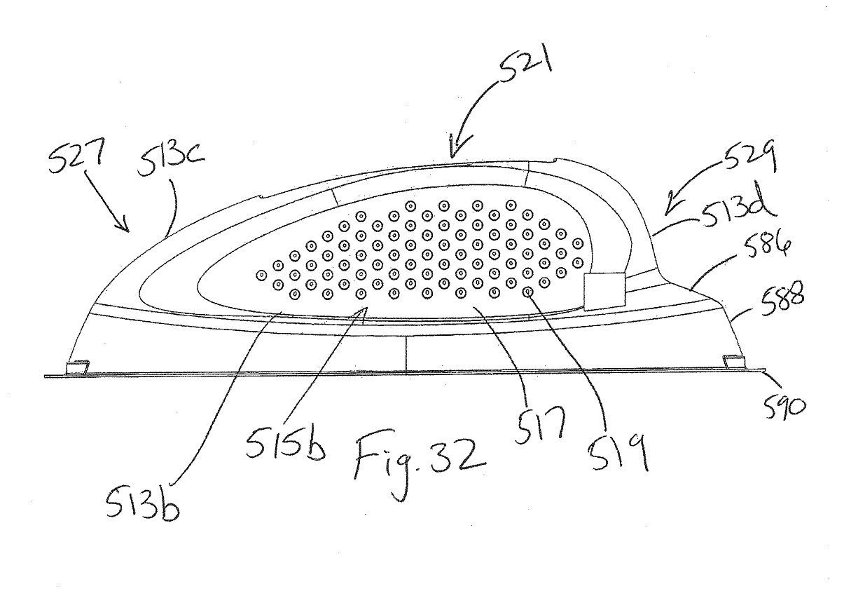

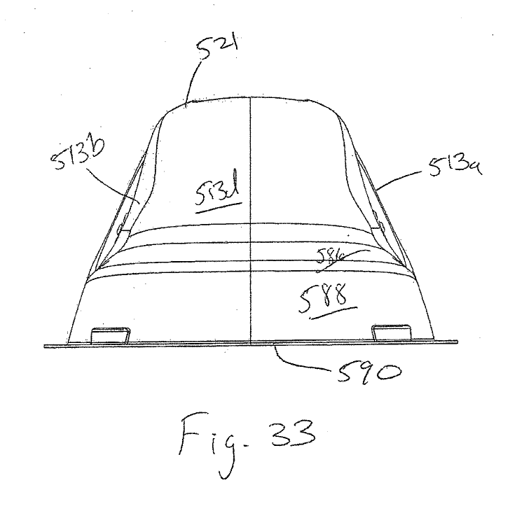

Referring momentarily to FIGS. 31 and 32, sides 513a and 513b define longitudinally extending first and second sides of housing 511 respectively. Referring now to FIGS. 33 and 34, side 513c defines a third side corresponding to front 527 of device 510 and side 513d defines a fourth side corresponding to a rear 529 of device 510. Sides 513c, 513d extend transversely with respect to sides 513a, 513b. Sides 513a, 513b include grooves 515a, 515b for receiving the user's hand and fingers. The grooves allow the user to comfortably grip a handle portion. Grooves 515a, 515b (see FIG. 32) may have a textured surface 517 having a number of spaced protrusions, indentations, or grip points 519 that assist the user in the gripping of the device 510. Grip points 519 may be integrally formed with housing 511 or may be coupled to grips 515a, 515b as is readily understood. Third side 513c and fourth side 513d may include indicia (not shown) over a portion as in previous embodiments of the present invention. Such indicia may provide an indication of how to operate device 510 or it may include an identification of a product name or maker of the device 510.

Referring again to FIG. 30, third side 513c defines a first elevation 573 at a point of intersection between third side 513c and top 521. Similarly, fourth side 513d defines a second elevation 575 at a point of intersection between fourth side 513d and top 521. As can be readily appreciated from FIGS. 30-32, the second elevation 575 is substantially higher than the first elevation 573 such that top 521 slopes downwardly from the second elevation to the first elevation. First elevation 573 defines a generally sloped portion from which third side 513c slopes generally forwardly and downwardly therefrom. Second elevation 575 defines a generally rounded portion 585 of handle 514 for receiving a palm of the user of the device 510.

Fourth side 513d extends generally downwardly from the rounded portion of second elevation 575 and has a slope that is approximately orthogonal with respect to a plane defined by a rear portion of top 521. Side 513d terminates in a generally rearwardly and horizontally extending ledge portion 586. Ledge portion 586 may be configured to receive the heel of a user's hand. An edge portion 588 extends generally downwardly from a rear of the ledge portion 586 and terminates in a horizontally extending rim 590, which is disposed around the perimeter of the housing 511. Rim 590 defines a generally rectangularly-shaped perimeter of housing 511. Rim 590 may extend around the entire perimeter or a portion of housing 511. Rim 590 may have rounded corners as shown, square corners, or any other such shape. Rim 590 may define another shape altogether such as an oval, circle, square or any other such shape. Rim 590 is configured to coupling to the base of the device 510 of the present embodiment. Understandably, the base of the present embodiment may have a shape that is complementary to the rim 590 so that the rim 590 and base are closely coupled to one another to seal the interior of housing 511 to define a chamber for receiving debris as will be discussed in further detail. Of course, the slope of side 513d may vary, but it is preferable that the slope of side 513d be steeper than that of side 513c to allow a user to more comfortably grasp device 510 as will be explained. The slope of side 513c defines an acute angle an acute angle about a front edge of the base portion 512 and the base portion 512

In operation, the user of device 510 grasps handle 514 with his or her palm about the rounded portion 585 defined by top 521 and rear side 513d. The user's fingers extend away from rear side 513d and toward front side 513c across top 521. Third side 513c is thus arranged to comfortably receive the ends of the user's fingers. In particular, the relatively wide nature and shallower slope of third side 513c allows the user's fingers to be comfortably received across the top 521 and over front side 513c. The slope of top 521 provides a comfortable angle at which to position the user's hand and fingers. The width of top 521 is such that at least two of the user's fingers are comfortably fit across the length of top 521. Preferably, the width of top 521 is sufficient to receive three of the user's fingers. Grooves 515a, 515b of first side 513a and second side 513b receive one of the user's thumb and the fifth finger, i.e., the digitus minimus.

FIGS. 36-39, illustrate yet another construction of the present invention in which the device 610 includes a debris collection chamber 632 that is selectively emptiable. Referring initially to FIG. 36, the device 610 is constructed in much the same manner as has been previously discussed in the present application. Device 610 includes a housing 610a coupled to a base portion 612. Housing 610a includes a top 611, sides 613a, 613b, 613c, and 613d and a handle portion 614. Handle portion 614 including a pair of side grooves 615a, 615b on opposing sides of the housing 610a for receiving the user's fingers.

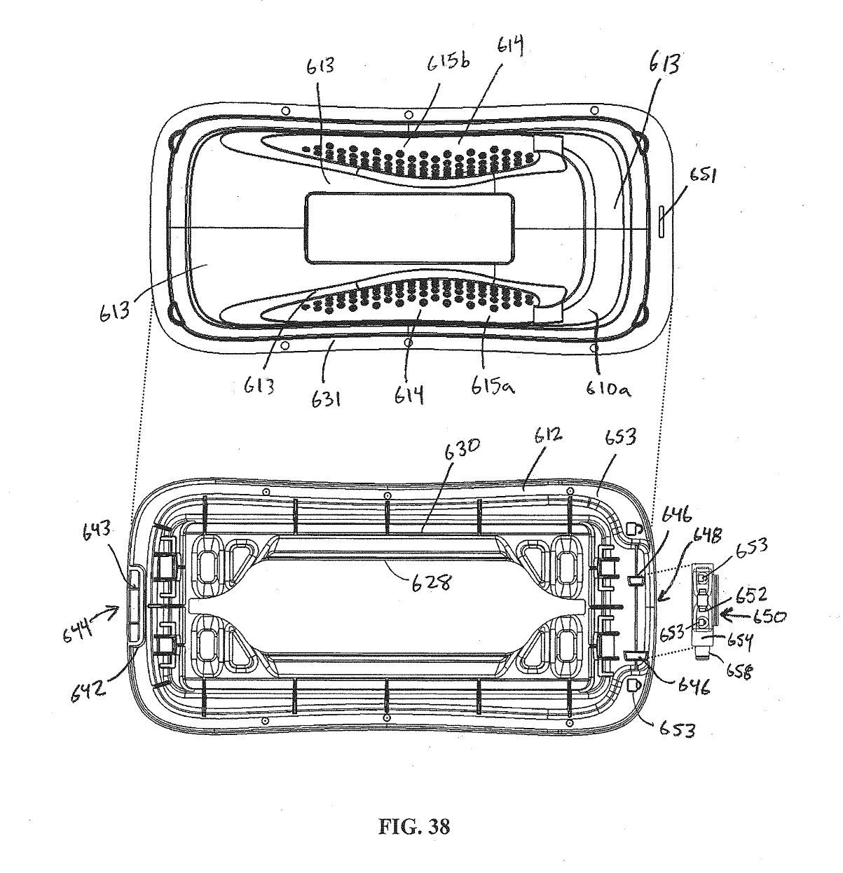

Referring momentarily to FIG. 38, base 612 defines a lower opening 628 for receiving at least one rotatable member 660. As illustrated, lower opening 628 is configured to receive a pair of rotatable members 660, 661 that cooperate with one another to pick up debris and deposit the debris in the debris collection chamber 632 as previously discussed herein. Of course, base 612 may be configured so as to support only a single rotatable member 660 as previously discussed. Base 612 further defines an upper opening 630 positioned above the lower opening and in communication with chamber 632.

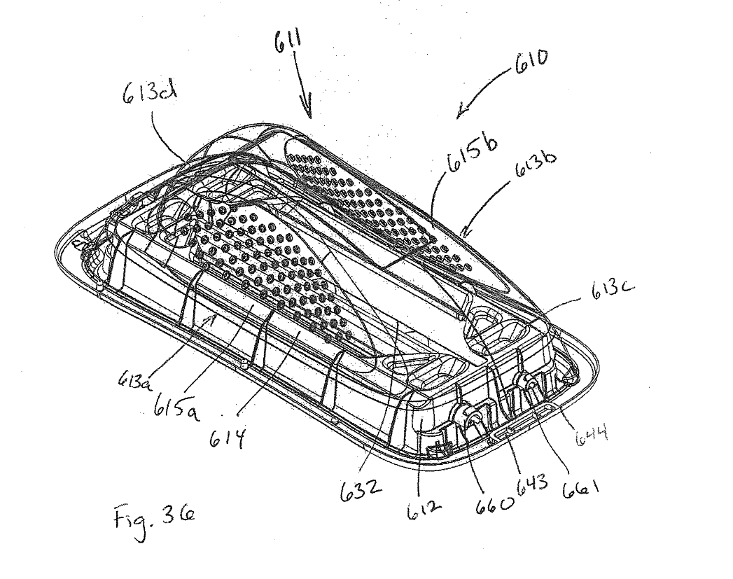

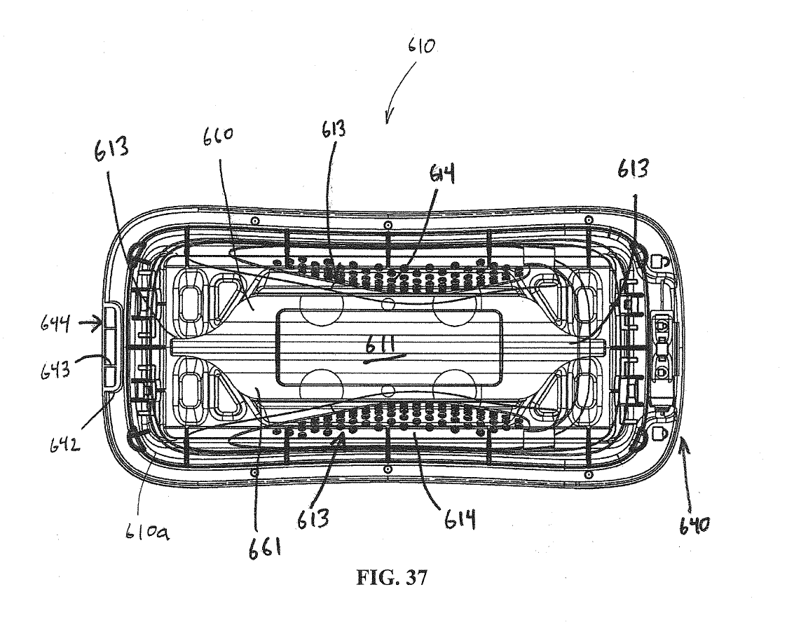

Referring now to FIGS. 37-39, a first construction of device 610 incorporating a debris collection chamber emptying assembly 640 is illustrated. In the present construction, base 612 includes a slot 642 defined by a flange 643 formed at a front edge 644. Understandably, slot 642 may be disposed in any of the edges of base 612 in keeping with the spirit of the present construction of device 610. Turning to FIG. 38 in particular, base 612 further includes a pair of raised receivers 646 on the rear edge 648. Receivers 646 may be integrally formed with base 612 and extend upwardly from a top of base 612 and define apertures for engaging with a locking portion of assembly 640.

Housing 610a is configured to cooperate with base 612 so as to be selectively removable therefrom so that the contents of the debris collection chamber 632 may be emptied as desired. Housing 610a includes a ridge 631 that extends around a periphery thereof. Ridge 631 is configured to be received within the slot 642 to secure the housing 610a to base 612. In particular, ridge 631 is configured to be slidingly engaged with slot 642 such that ridge 631 is secured within slot 642 by flange 643 to ensure that housing 610a remains coupled to base 612.

Turning to FIGS. 38 and 39, on an opposing end of housing 610a, ridge 631 includes a locking mechanism 650 coupled thereto. Locking mechanism 650 includes an upper member 652 and a lower member 654 integrally formed with one another and coupled around an edge of ridge 631 and through an elongate aperture 651 formed in the ridge 631. Upper member 652 defines a user actuatable switch that includes a downwardly extending tab 649 that extends through the elongate aperture 651 in ridge 631 and engages lower member 654. Lower member 654 includes a first tab 656 and a second tab 658 each of which is selectively slidably engageable with one of receivers 646 to secure housing 610a to base 612. Locking mechanism 650 is selectively positionable between an unlocked position in which the first tab 656 and second tab 658 are positioned such that they do not engage receivers 646 and a locked position in which the first tab 656 and second tab 658 are engaged with the receivers 646 to thereby lock the housing 610a to the base 612.

In operation, housing 610a is secured to base 612 by engaging ridge 631 with slot 642 such that ridge 631 is secured within slot and beneath flange 643. With locking mechanism 650 positioned in the unlocked position, the opposing end of housing 610a engages rear edge 648 of base 612 such that the entirety of ridge 631 is received within a perimeter of base 612. To secure housing 610a to base 612, the locking mechanism 650 is slid from the unlocked position to the locked position. In particular, the user engages the top member 652 with one or more of his or her fingers and slides the locking mechanism 650 so that the tabs 656 and 658 carried by the lower member 654 engage the receivers 646. In this manner, the housing 610a is now secured to base 612 so that it may not be removed, and it is therefore ready for use by the user. Once the chamber 632 becomes filled with debris, the user may remove the housing 610a from base 612 to empty the chamber 632. To unlock the housing 610a from base 612, the user engages top member 652 and slides locking mechanism 650 so that the tabs 656 and 658 are disengaged from the receivers 646. The housing 610a is therefore removable from base 612 for emptying of chamber 632 so that the device 610 may then be subsequently reused once the debris is disposed of.

Base 612 may include indicia 653 over a portion thereof to indicate the direction which to slide locking mechanism 650 to lock the housing 610a to base 612. Similarly, housing 610a may include such indicia. Further, locking mechanism 650 may include such indicia 653 on top member 652. For instance, as shown in FIG. 38, upper member 652 may have a pair of sloped side surfaces that slope toward a center of upper member 652 to define a peak thereof Each of the sloped side surfaces may include an indication as to which direction locking mechanism 650 is to be moved to position locking mechanism 650 in the locked or unlocked position.

Referring now to FIGS. 40-41, an assembly 640 for enabling the selective emptying of chamber 632 is illustrated in which the front edge 675 of base 612 includes an integrally formed hinge 655 that is integrally formed with and coupled to housing 610a. Locking mechanism 650 according to the present embodiment incorporates a slider 666 that is slidingly coupled to base 612 for movement along an edge thereof Slider 666 is configured to selective engage a portion of ridge 631 to thereby couple housing 610a and base 612 to one another. Housing 610a includes a cut-out portion 667 along a corresponding portion of ridge 631. Thus, to secure base 612 to housing 610a, the housing 610 is engaged with base 612 and slider 666 is then slid into engagement with ridge 631. In this manner slide 666 receives a portion of ridge 631 to thereby secure base 612 to housing 610a. To remove housing 610a from base 612, the slider 666 is slid toward cut-out portion 667 such that slider 666 is disengaged from ridge 631. In this manner, housing 610a is now removable from base 612 for emptying of chamber 632.

Turning to FIGS. 42-43, another construction of device 610 employing a hinge 655 is illustrated. In the present embodiment, hinge 655 is not integrally formed between housing 610a and base 612 but rather, base 612 includes a pair of receivers 656 that extend outwardly from one edge of a side thereof The receivers 656 are spaced from one another along a length of base 612; of course it is understood that receivers 656 may be replaced by a single, unitary and centrally located receiver 656 or a number of additional receivers 656 as desired. Receivers 656 are integrally formed with the edge of base 612 and extend outwardly therefrom to define a cylindrical portion 658. Cylindrical portions are hollow and configured to receive an elongate rod 659 coupled to an edge of housing 610a. Rod 659 is received through the one or more receivers 656 to enable housing 610a to rotate about an axis defined thereby. On an opposing side of base 612, a button 663 is integrally formed and extends outwardly therefrom. Button 663 may be round as illustrated or any number of alternative shapes. Housing 610a includes an aperture 665 disposed on the side opposite rod 659 configured to engage button 663 to secure housing 610a to base 612.

In this manner, housing 610a is secured to base 612. To release housing 610a from base 612, the button 653 is depressed such that it is disengaged from aperture 665 and housing 610a is then freely rotatable about hinge 650 so that chamber 632 may be emptied. Button 663 may be biased so that when the user disengages the button 663, it returns to its initial, extended position such that when the user desires to secure the housing 610a to base 612, the user may rotate housing about hinge 655 and engage the aperture 665 with button 663 to secure the housing 610a and base 612 to one another.

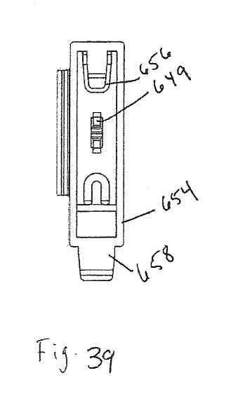

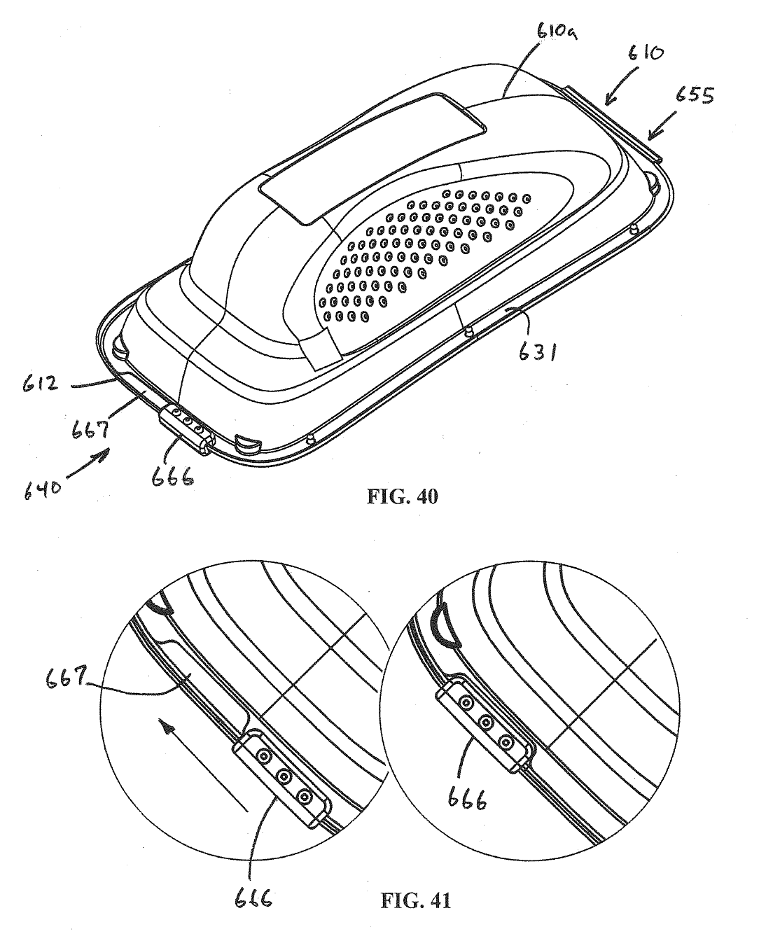

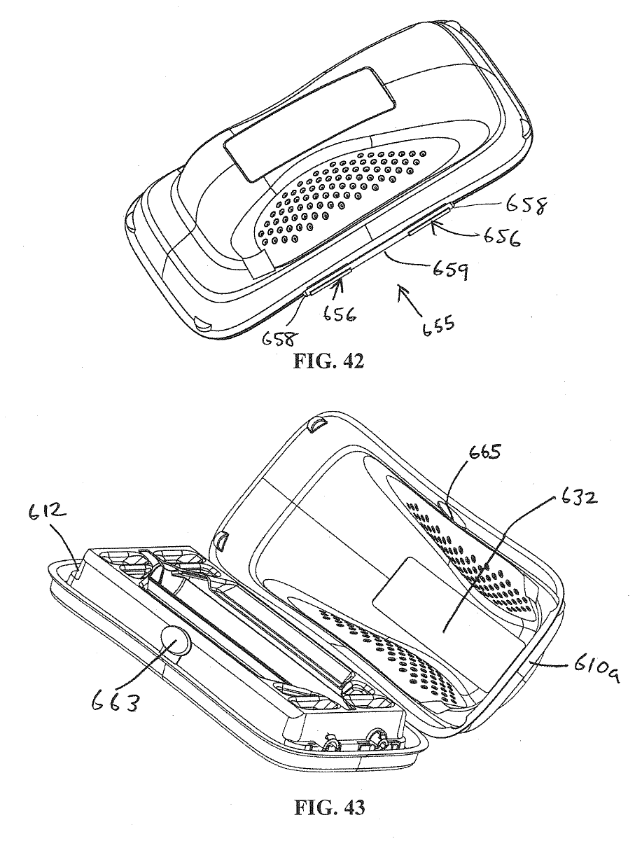

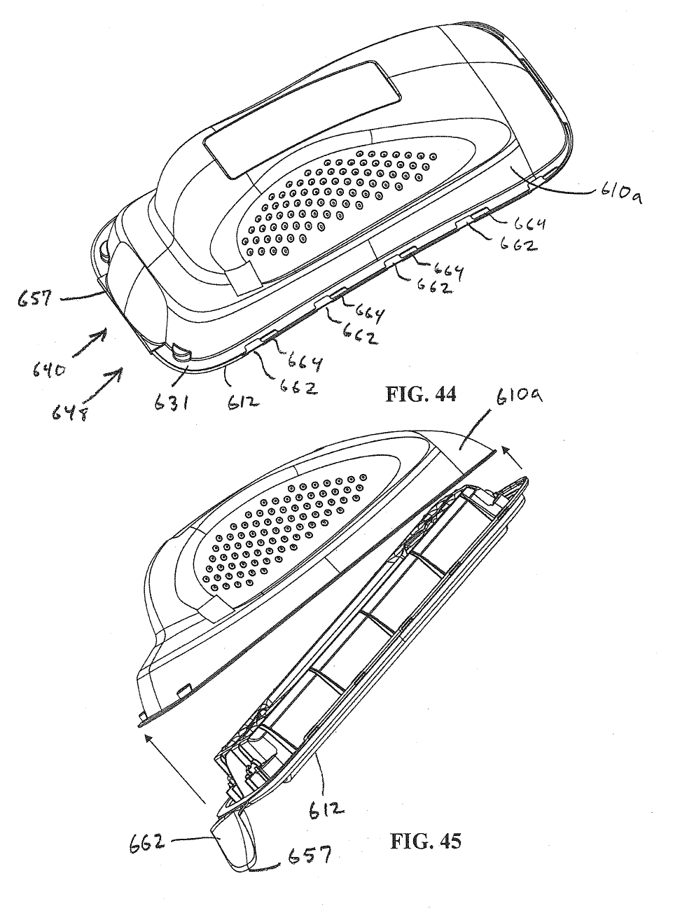

Referring now to FIGS. 44-45, another construction of device 610 incorporating an assembly 640 according to the present invention is shown. Base 612 of the present construction includes a selectively rotatable latch 660 on a rear side 648 thereof; of course, latch 660 may be provided on any of the sides of base 612 in keeping with the present invention, and the illustrated embodiment is but an exemplary construction. Latch 660 is sized and shaped to accommodate the rear side of housing 610a and includes a generally concave surface 662 configured to engage the rear side of housing 610a. For instance, latch 660 may be configured to engage an edge portion 688 of housing 610a to thereby secure base 612 to housing 610a.

Base 612 may further include a number of inwardly extending projections 662 disposed about a perimeter thereof. Projections 662 are configured to engage rim 631 of housing 610a to secure housing 610a to the base 612. In particular, projections 662 cooperate with base 612 to receive rim 631 therebetween. Rim 631 includes a number of spaced notches 664 arranged to receive the projections 662 to position housing 610a in an unlocked position. To release housing 610a from base 612 to empty the contents of the debris collection chamber 632, the latch 660 is rotated from engagement with housing 610a about a horizontal axis defined by a perimeter of base 612. Once the latch 660 is disengaged from the housing 610a, housing 610a is simply slid forward with respect to base 612 such that projections 662 are aligned with notches 664 so that the projections 662 and base 612 are no longer received around rim 631. Once the housing 610a and base 612 are unlocked, the housing 610a may be removed and its contents emptied. To lock the housing 610a to the base 612 after emptying, the housing 610 is engaged with base 612 and slid rearwardly with respect thereto so that projections 662 engage the rim 631. Once the projections 662 and rim 631 are engaged, the latch 660 is rotated about the horizontal axis into engagement with housing 610a to secure the housing 610a to the base 612.

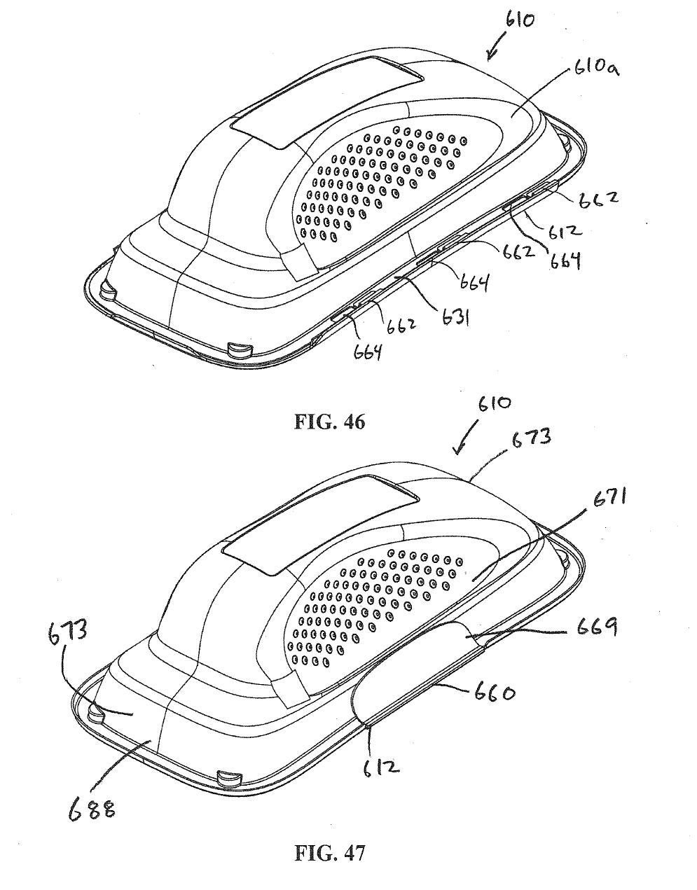

Turning to FIG. 46, another embodiment is illustrated in which device 610 does not incorporate a latch like in the immediately preceding embodiment but includes a number of spaced inwardly extending projections 662 on base 612 that are selectively engageable with rim 631. As in the previous embodiment, housing 610a is removed for emptying by sliding housing 610a forward with respect to base 612 so that the projections 662 are disengaged from rim 631 and aligned with notches 664 such that housing 610a may be removed.

Referring now to FIGS. 47, another construction of the device 610 is illustrated in which base 612 includes a latch 660. Latch 660 of the present embodiment is positioned along one of the sides of base 612 and configured to engage a side wall 669 of housing 610a. Latch 660 is rotatable about a horizontal axis defined by an edge of base 612 so as to engage side wall 669 just below gripping surfaces 671. In the illustrated construction, only a single latch 660 is provided although it is understood that base 612 may include one or more additional latches in keeping with the spirit of the present invention. For instance, base 612 may include a latch on the opposing side thereof for engaging side wall 669 of base 612. Alternatively, or in addition to, base 612 may include latches along one or both of the end walls 673 thereof. For instance, a latch 660 like that of the previous embodiment may be included in which the latch engages edge portion 688 of housing 610a. Latch 660 may include one or more fins (not shown) or similar such members that extend along a length thereof that are configured to ensure a tight fit between the contour of latch 660 and side wall 669 of housing 612. In this manner, latch 660 may be kept in relatively close contact with housing 610a when in the locked position despite the occurrence of warping of the material due to repeated uses or the like.

Referring now to FIGS. 48, yet another construction of device 610 incorporating an assembly 640 is illustrated. Housing 610a of the present disclosure includes a slot 668 along one edge thereof In particular, slot 668 may be provided for along ridge 631. Slot 668 may be incorporated into a rear of housing 610a; of course, it is generally understood that slot 668 may be incorporated anywhere about the housing 610a as long as it is capable of operating as will be described herein. Base 612 includes a corresponding vertically extending tab 670. Tab 670 is generally elongate and relatively flexible. Tab 670 includes a catch 672 positioned near a bottom of tab 670. Catch 672 is configured to engage a portion of housing 610a to secure it to base 612 as will be discussed. Tab 670 further includes a user engagement portion 674 configured to be engaged by the user to selectively unlock the housing 610a from base 612.

In operation, housing 610a is lowered onto base 612 such that tab 670 is received through slot 668. Tab 670 is arranged such that once housing 610a comes to rest on base 612 tab 670 is engaged with housing 610a via catch 672. In particular, tab 670 extends at least partially rearwardly such that when housing 610a is lowered onto base 612, the catch 672 is positioned for engagement with ridge 631. In this manner, housing 610a is secured to base 612 such that device 610 is ready for use. To unlock housing 610a from base 612, the user engages engagement portion 674 with her or her fingers and pushes it toward a front of device 610 such that catch 672 is disengaged from ridge 631, and therefore housing 610a is unsecured with respect to base 612 so that it may be removed for emptying the contents of chamber 632.

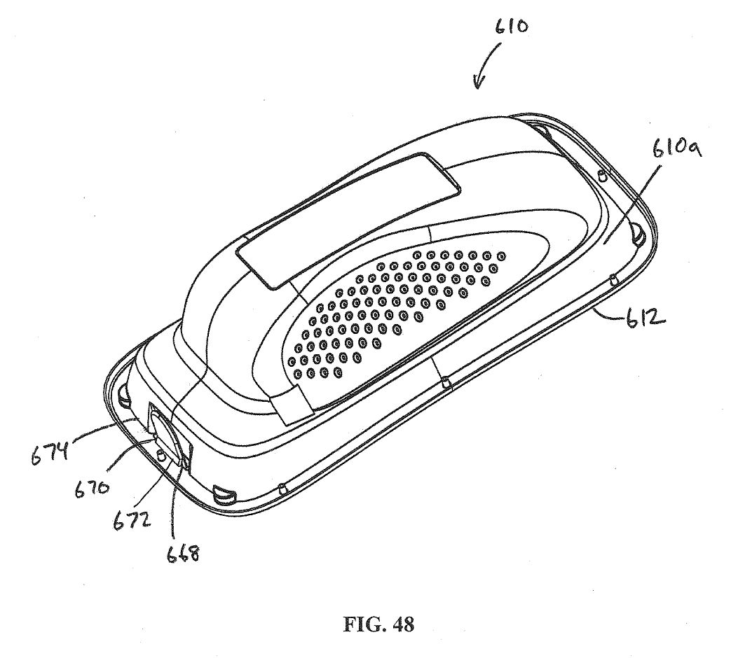

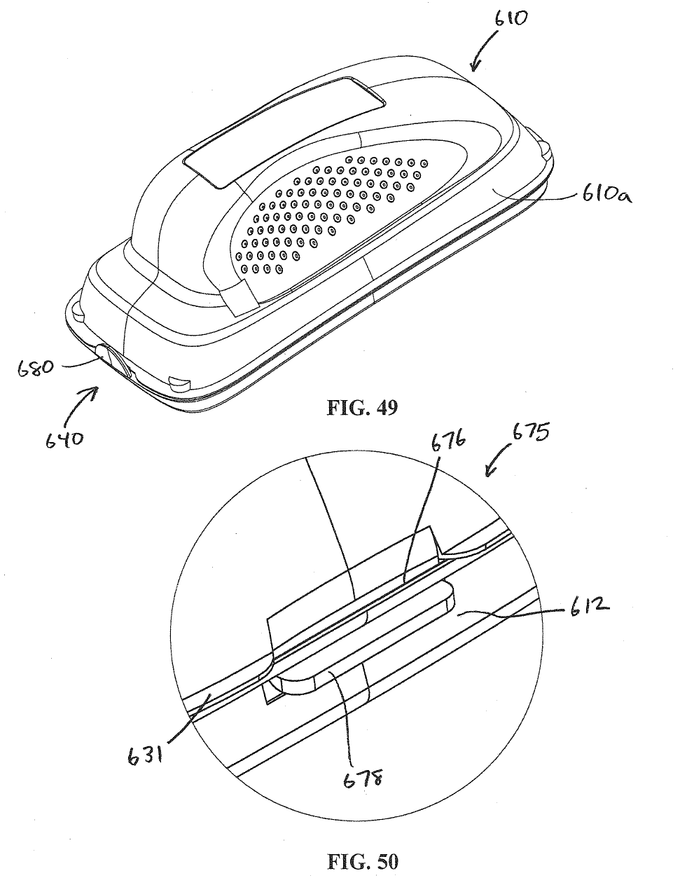

Now referring to FIGS. 49-50, another construction incorporating an assembly 640 according to the present invention is shown and includes a slot 676 formed in base 612 at a front edge 675 thereof. Housing 610a includes a corresponding tab 678 formed near a front edge 675 thereof Tab 678 may be generally hook shaped and is configured for being inserted through slot 676 to loosely secure housing 610a to base 612. On an opposing end of device 610, base 612 includes a lever member 680 that is configured to engage a portion of ridge 631. In particular, when the assembly 640 is in an unlocked configuration, lever member 680 is positioned rearward of a rear edge of ridge 631 so that housing 610a may be removed from base 612. To secure housing 610a to base 612, the lever member 680 is slid forwardly with respect to housing 610a such that a portion of lever member 680 engages ridge 631. Thus, to empty device 610 according to the present embodiment, the user slides lever member 680 rearward to disengage the lever member 680 from ridge 631. Housing 610a is then rotated about a horizontal axis defined by slot 676 and tab 678 such that housing 610a remains loosely coupled to base 612 but such that chamber 632 may be emptied of accumulated debris; of course, if desired, housing 610a may be entirely disengaged from base 612 by removing tab 678 from engagement with slot 676.

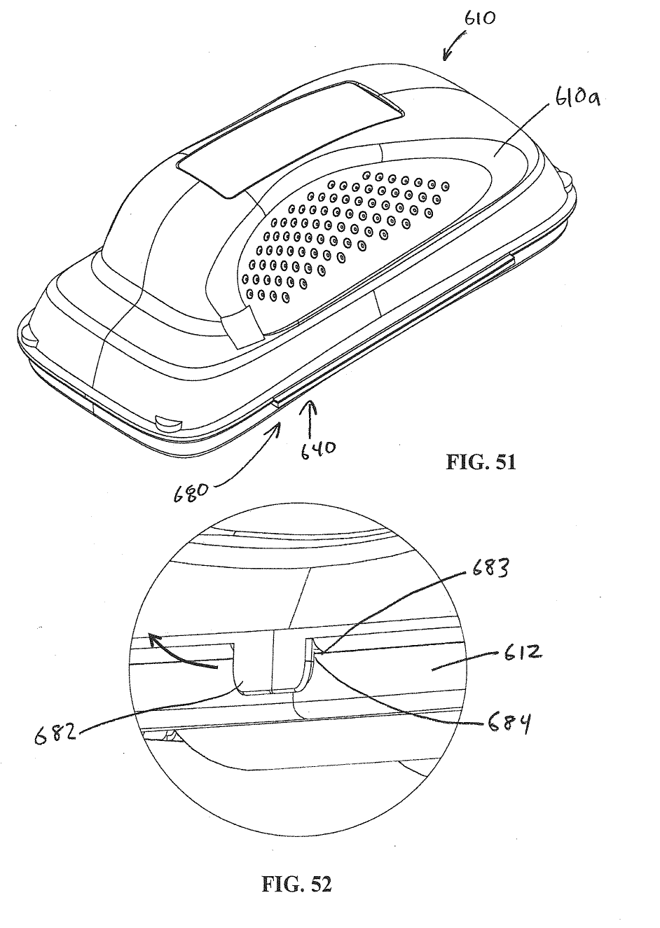

Turning now to FIGS. 51-52, yet another construction of assembly 640 is illustrated. In the present embodiment, housing 610a and base 612 are integrally formed along at least a portion of one side of device 610. In particular, a hinge 680 is provided along the one side of device 610 such that housing 610a may be rotated about a horizontal axis defined by hinge 680 so as to empty the contents of chamber 632. On an opposite side of device 610, housing 610a includes a downwardly extending tab 682 configured to engage a slot 684 formed in base 612. Tab 682 is selectively releasable from slot 684 such that housing 610a may be rotated about hinge 680 for emptying of chamber 632. Tab 682 may include a catch 683 or similar structure on a rear side thereof. Catch 683 is configured to engage an edge of slot 684 to thereby secure housing 610a to base 612. To release housing 610a from base 612, the user of device 610 pulls tab 682 away from device 610 such that catch 683 is disengaged from slot 684 such that housing 610a may be rotated about hinge 680. To secure housing 610a to base 612, housing 610a is rotated about hinge 680 so that tab 682 engages slot 684 and is received therein.

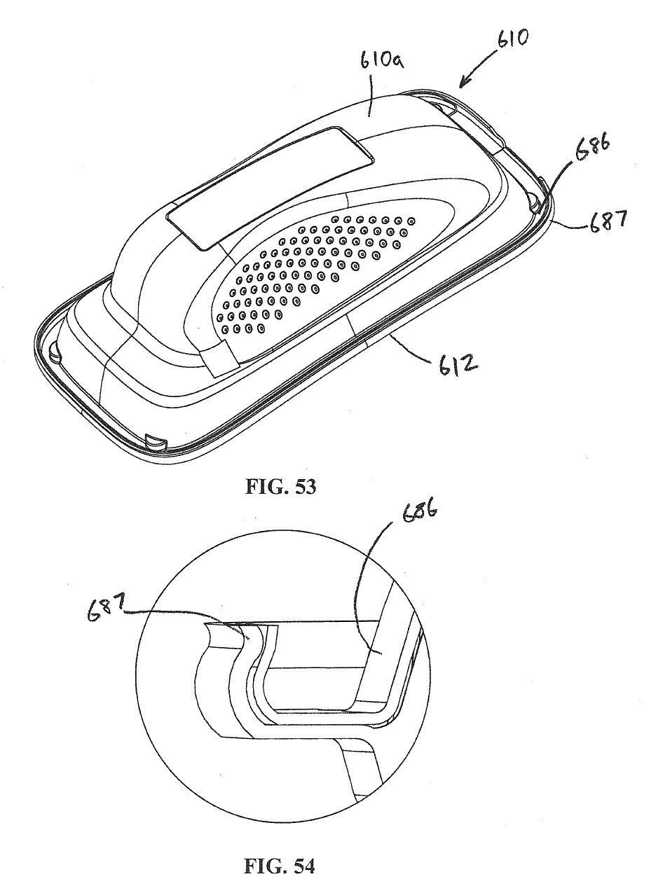

Referring now to FIGS. 53-54, another construction of the device 610 including an assembly 640 is shown. In the present embodiment, housing 610a and base 612 include complementary rims 686, 687 respectively. Rim 687 is configured to receive rim 686 in a locking manner. In particular, rims 686 and 687 are constructed in a complementary manner such that they may be snap-fit to one another to secure housing 610a and base 612 to one another. Rim 687 of housing 610a may extend around the entire periphery of housing 610a while base 612 may have a portion devoid of rim 686. In this manner, a user may be able to grasp the portion of rim 687 overlapping the area of base 612 without rim 686 so that the user may pull the rims 686 and 687 apart to remove housing 610a from base 612.

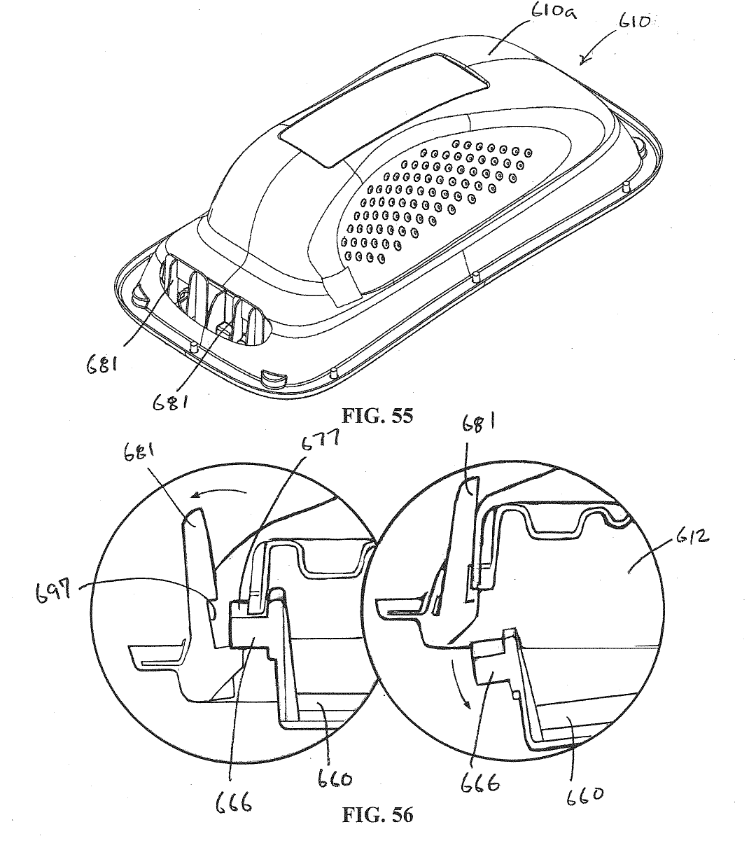

FIGS. 55-56, illustrate another construction of device 610 configured to allow chamber 632 to be emptied. In the present embodiment, one or more of rotatable members 660, 661 are selectively removable from base 612 so that the device 610 may be emptied. In particular, rotatable members 660, 661 may include protrusions 666a, 666b, 666c, and 666d, collectively protrusions 666, as previously discussed but wherein at least one of the protrusions 666 includes a notch 677 for coupling to a portion of base 612. For instance, notch 677 may be engaged with a rocker or lever arm 681 that includes a complementary notch 697 formed over a portion thereof and which is configured to be received around protrusion 666 to engage the notch 677 thereof. Lever member 681 is configured to engage the notch 677 of protrusions 666 when in the locked position and configured to be selectively releasable so that the rotatable members 660, 661 may be removed as desired. Lever member 681 may extend through a rear wall of housing 610a such that lever member 681 is positioned for actuation by the user of device 610. To release the rotatable members 660, 661, the user pulls the lever member 681 rearward with respect to housing 610a such that the notch 697 of lever member 681 is moved rearward with respect to protrusion 666 and is thereby disengaged from notch 677. Accordingly, rotatable members 660, 661 are then freely releasable from base 612 for emptying of chamber 632. The lever member 681 may be biased so that after the user releases the lever member 681, the lever member 681 returns to a forward position so that when the rotatable members 660, 661 are reinserted into base 612, they are simply snapped back in place such that protrusions 666 are engaged with lever member 681 via notches 677 and 697 respectively.

Understandably, the present embodiment may also be used as a means for replacing worn rotatable members 660, 661. It is generally understood that after repeated uses, the rotatable members 660, 661 may become less effective such that replacement is therefore desirable. In this manner, the user need not replace the entire device 610 but can simply replace the worn rotatable members 660, 661 such that the device 610 may be subsequently reused.

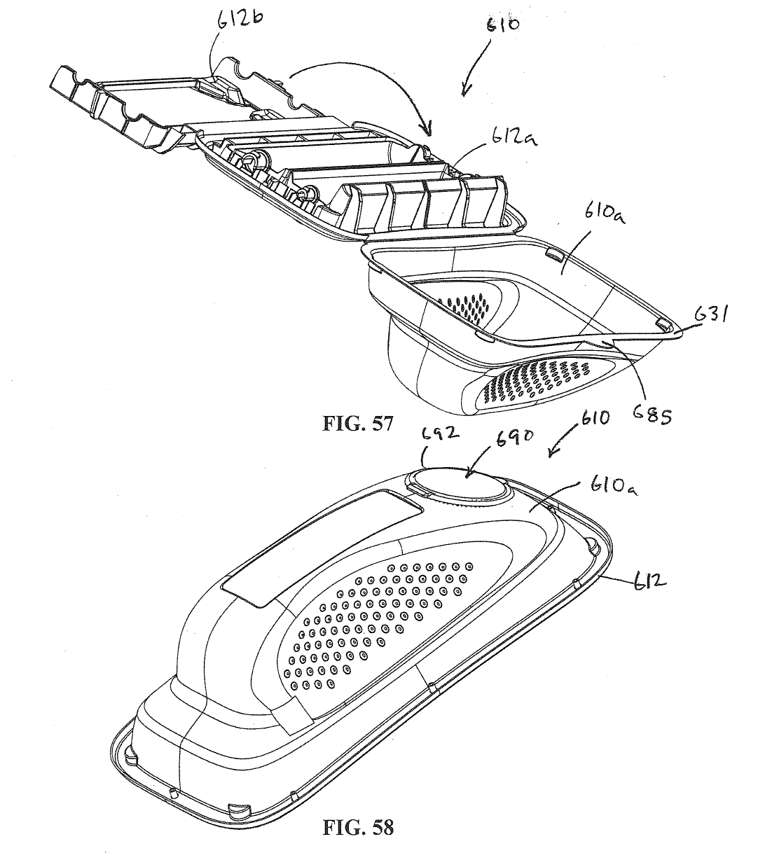

FIG. 57 illustrates yet another construction of device 610 in which means for emptying chamber 632 is provided. In the present embodiment, device 610 includes an integrally formed, foldable construction in which housing 610a is integrally coupled along one side of ridge 631 to a lower base 612a, which in turn is coupled to an upper base 612b along an opposing side of lower base 612a. In this manner, housing 610a and base 612 are hingedly coupled to one another such that housing 610a may be selectively disengaged from base 612 for emptying of chamber 632. Upper base 612b may include a perimeter configured to be engaged by a perimeter of housing 610a so that the housing 610a and base 612 may be snap-fit to one another to secure them to one another. Housing 610a may include a tab 685 that extends from an edge thereof that is configured to be grasped by the user to separate housing 610a from base 612. In yet another construction of device 610 illustrated in FIGS. 58, housing 610 includes a port 690 through which access to chamber 632 may be provided to a secondary cleaning device such as a nozzle of a vacuum or similar such tool. Housing 610a may include a cover 692 that is selectively removable from port 690 to prevent the contents of chamber 632 from exiting device 610. Cover 692 may be hingedly coupled to the housing 610a so that when the user wants to access the port 690 for removal of the debris in chamber 632, the user lifts cover 692 and then inserts the secondary cleaning tool through port 690 and into chamber 632 for removal of the contents thereof.

It is understood that any of the foregoing methods and constructions for emptying chamber 632 are not mutually exclusive and one or more constructions may be incorporated into the device 610 of the present invention. Moreover, device 610 may be any of the devices discussed herein and may have any construction previously discussed in keeping with the spirit of the present invention. For example, device 610 may include a single rotatable member as FIGS. 25A-29. Of course, device 610 is not limited to any one construction discussed herein and may incorporate any number of variations previously discussed.

As mentioned, various components of the device can be attached by sonic heat staking or hot melt glue. The heat staking process may have a feature that shows orientation for future troubleshooting

The velour cleaning material may be applied to the rollers as a sort of label; that is, one side has an adhesive and one side has a unidirectional fabric. Alternatively, the cleaning fabric may include a properly cut and sized piece of material hot glued to the roller. The fabric may have semi circular tabs cut out to align with corresponding structures on the rollers. This makes it easier to fit the fabric to the roller during assembly. While the cleaning material is typically red velour, blue and other, lighter colors such as white and yellow may be used. For example, the lighter colors may be beneficial as they will better show dirt and debris.

The cleaning fabric preferably has some cushion. The cushion density makes a difference in exerted force. The velour wears out after time, for example, 6 hours to 8 hours of use.

In one embodiment, the roller fasteners may consist of de-nest lugs embedded in the top housing. In such an embodiment, the roller removal force is about 16 pounds.

The device is preferably made of transparent 100% recyclable R-PET or some other suitable plastic resin.

In another embodiment, the inside of the device is sprayed with glue or some other adhesive. This feature attracts and holds the debris to the inner walls of the device. This feature will promote the fact that the device is disposable.

Various other features, embodiments and advantages of the present invention are contemplated as being within the scope of the following claims particularly pointing out and distinctly claiming the subject matter regarded as the invention.

We hereby claim:

1. A fabric cleaning device comprising:
a base;
a housing releasably coupled to the base comprising a handle portion and defining a debris collection chamber and selectively positionable between a locked position in which the housing is secured to the base for operation of the fabric cleaning device and an unlocked position in which the housing is removable from the base for emptying the contents of the debris collection chamber;
at least one rotatable member secured within the base, extending at least partially out of the base and including a debris removing surface configured to pick up debris from a surface and deposit the debris in the debris collection chamber.

2. The fabric cleaning device of claim 1, further comprising a locking mechanism disposed on one of the housing and the base and configured to selectively engage the other of the housing and the base.

3. The fabric cleaning device of claim 2, wherein the locking mechanism comprises a latch configured to engage a receiver to thereby secure the housing to the base.

4. The fabric cleaning device of claim 3, wherein the latch includes at least one tab configured to engage the receiver.

5. The fabric cleaning device of claim 2, wherein the locking mechanism comprises an upper member coupled to a lower member through an aperture in the housing, wherein the locking mechanism is slidable along the length of the aperture to selectively lock and unlock the housing with respect to the base.

6. The fabric cleaning device of claim 2, further comprising a slot on an end of the base and configured to receive a portion of the housing, wherein the locking mechanism is positioned on an end opposite that of the slot.

7. The fabric cleaning device of claim 6, wherein housing comprises a ridge around a perimeter thereof and the slot is configured to receive a portion of the ridge.

8. The fabric cleaning device of claim 2, wherein the locking mechanism is provided on a first end of the device and further comprising a hinge formed between the housing and the base, and wherein when the housing is unlocked from the base, the housing is rotatably about the hinge.

9. The fabric cleaning device of claim 2, wherein the locking mechanism comprises a plurality of inwardly extending projections coupled to the base and configured to selectively receive a rim of the housing between the projections and the base to secure the housing to the base.

10. The fabric cleaning device of claim 9, wherein the housing includes a plurality of notches disposed about the rim and configured to be selectively aligned with projections to unlock the housing with respect to the base.

11. The fabric cleaning device of claim 10, further comprising a latch carried by the base and rotatably engageable with the housing to secure the housing to the base.

12. A cleaning device comprising:
a base including an upper aperture and a lower aperture;
a housing coupled to the base and defining a debris collection chamber in communication with the upper aperture;
at least one rotatable cleaning member movably secured in the lower aperture of the base and configured to pick up debris off a surface and transfer the debris to the debris collection chamber; and
wherein the debris collection chamber is selectively emptiable.

13. The cleaning device of claim 12, wherein a locking mechanism is disposed on the housing and is configured to selectively engage the base.

14. The cleaning device of claim 13, wherein the locking mechanism comprises a latch configured to engage a receiver on the base to thereby secure the housing to the base.

15. The cleaning device of claim 14, wherein the latch includes at least one tab configured to engage the receiver.

16. The cleaning device of claim 15, wherein the base includes a slot on an end of the base, the slot being configured to receive a portion of the housing, and the locking mechanism is positioned on an end of the housing opposite that of the slot.

17. A method of cleaning a surface comprising the steps of:
grasping a cleaning device by a handle, the cleaning device having a housing defining a debris collection chamber and coupled to a base which supports at least one rotatable cleaning member;
sliding the cleaning device in a first direction to pick up debris off of the surface on the at least one rotatable cleaning member;
sliding the cleaning device in a second direction that is opposite the first direction to move the debris from the at least one rotatable cleaning member to the debris collection chamber; and
emptying the debris of the debris collection chamber; and

18. The method of claim 17 further comprising the step of disengaging the housing from the base.

19. The method of claim 18 further comprising the step of, engaging the housing with the base.

20. The method of claim 17, wherein the base includes a slot for receiving a rim of the housing at one end of the cleaning device and wherein the base includes at least one receiver at an opposing end for receiving a locking mechanism carried by the housing to selectively secure the housing to the base.
